(19) United States
(12) Patent Application Publication
(10) Pub. No.: US 2026/0252836 A1
(43) Pub. Date: Aug. 27, 2026

(54) PROCESSING APPARATUS, PROCESSING METHOD, AND NON-TRANSITORY COMPUTER-READABLE RECORDING MEDIUM

(71) Applicant: SHARP KABUSHIKI KAISHA, Osaka (JP)

(72) Inventor: YOSHINORI MURAKAMI, Osaka (JP)

(21) Appl. No.: 19/443,253

(22) Filed: Jan. 8, 2026

(30) Foreign Application Priority Data
Jan. 23, 2025 (JP) 2025-009631

(51) Int. Cl. G06K 15/02

(52) U.S. Cl. CPC G06K 15/1877; G06K 15/1852; G06K 15/188

(57) ABSTRACT

A processing apparatus includes a conversion unit configured to perform resolution conversion on an input multi-value image; an acquisition unit configured to acquire connected region information in which a plurality of pixels are connected, from a binary image obtained by binarizing a low resolution image after conversion; an extraction unit configured to calculate a pixel count, an edge pixel ratio, and a color pixel ratio for each connected region based on the connected region information; a first determination unit configured to determine, for each connected region, an attribute of the region based on the pixel count, the edge pixel ratio, and the color pixel ratio for the connected region; and a generation unit configured to generate image data by applying predetermined image processing in accordance with the attribute of the region.

### CROSS-REFERENCE TO RELATED APPLICATION

The present application claims priority from Japanese Application JP 2025-009631, the content of which is hereby incorporated by reference into this application.

### BACKGROUND OF THE INVENTION

### 1. Field of the Invention

The present disclosure relates to an information processing apparatus and the like.

### 2. Description of the Related Art

In an image processing apparatus such as a multifunction apparatus, when a document in which a character region, a photograph region, a halftone dot region, and the like are mixed together through copy job is read by a scanner and printed, it is necessary to identify and separate each region (hereinafter, this may be referred to as region separation) and to perform appropriate processing corresponding to each separated region in order to reproduce a high quality printing result.

Further, when print data described in a language such as a page description language (PDL) is printed by a printer job, rendering (designating attributes (text, graphics, and photographs) of drawing objects into the print data) is performed on an image, and image processing appropriate for each region is executed in accordance with the information.

For example, in the related art, there is a technology related to region separation using a pixel block that includes an attention pixel.

### SUMMARY OF THE INVENTION

An object of the present disclosure is to provide a processing apparatus or the like that can reproduce a high quality printing result when printing a document in which character regions, photograph regions, halftone dot regions, and the like are mixed together.

To achieve the above object, a processing apparatus according to the present disclosure includes a conversion unit configured to perform resolution conversion on an input multi-value image; an acquisition unit configured to acquire connected region information in which a plurality of pixels are connected, from a binary image obtained by binarizing a low resolution image after conversion; an extraction unit configured to calculate a pixel count, an edge pixel ratio, and a color pixel ratio for each connected region based on the connected region information; a first determination unit configured to determine, for each connected region, an attribute of the region based on the pixel count, the edge pixel ratio, and the color pixel ratio for the connected region; and a generation unit configured to generate image data by applying predetermined image processing in accordance with the attribute of the region.

Further, a processing method according to the present disclosure includes performing resolution conversion on an input multi-value image; acquiring connected region information in which a plurality of pixels are connected, from a binary image obtained by binarizing a low resolution image after conversion; calculating, based on the connected region information, a pixel count, an edge pixel ratio, and a color pixel ratio for each connected region; determining, for each connected region, an attribute of the region based on the pixel count, the edge pixel ratio, and the color pixel ratio for the connected region; and generating image data by applying predetermined image processing in accordance with the attribute of the region.

Further, a non-transitory computer-readable recording medium according to the present disclosure includes a program recorded thereon, the program causing a computer to realize: a conversion function of performing resolution conversion on an input multi-value image; an acquisition function of acquiring connected region information in which a plurality of pixels are connected, from a binary image obtained by binarizing a low resolution image after conversion; an extraction function of calculating, based on the connected region information, a pixel count, an edge pixel ratio, and a color pixel ratio for each connected region; a determination function of determining, for each connected region, an attribute of the region based on the pixel count, the edge pixel ratio, and the color pixel ratio for the connected region; and a generation function of generating image data by applying predetermined image processing in accordance with the attribute of the region.

According to the present disclosure, it is possible to provide a processing apparatus or the like that can reproduce a high quality printing result when printing a document in which character regions, photograph regions, halftone dot regions, and the like are mixed together.

### BRIEF DESCRIPTION OF THE DRAWINGS

FIG. 1 is an appearance perspective view illustrating an overall configuration of a multifunction apparatus according to a first embodiment.

FIG. 2 is a diagram illustrating a functional configuration of the multifunction apparatus according to the first embodiment.

FIG. 3 is a diagram illustrating a functional configuration of a document feature determination unit according to the first embodiment.

FIG. 4 is a diagram illustrating an exclusion region excluded from histogram generation targets.

FIG. 5 is a diagram illustrating a functional configuration of a region separation processing unit according to the first embodiment.

FIG. 6 is a table illustrating label region data according to the first embodiment.

FIG. 7 is tables illustrating processing operations performed by a color correction unit, a black generation and under-color removal unit, a spatial filter processing unit, and a gradation reproduction processing unit in accordance with a region identification signal.

FIG. 8 is a flowchart illustrating a processing flow according to the first embodiment.

FIG. 9 is a flowchart illustrating a flow of processing according to the first embodiment.

FIG. 10 is a flowchart illustrating a flow of processing according to the first embodiment.

FIG. 11 is a diagram illustrating an operation example according to the first embodiment.

FIGS. 12A and 12B are diagrams illustrating operation examples according to the first embodiment.

FIGS. 13A and 13B are diagrams illustrating operation examples according to the first embodiment.

FIGS. 14A and 14B are diagrams illustrating operation examples according to the first embodiment.

FIGS. 15A and 15B are diagrams illustrating operation examples according to the first embodiment.

FIG. 16 is a diagram illustrating an operation example according to the first embodiment.

FIGS. 17A and 17B are diagrams illustrating operation examples according to the first embodiment.

FIG. 18 is a diagram illustrating a functional configuration of a region separation processing unit according to a second embodiment.

FIG. 19 is a table illustrating processing executed by a region identification signal integration unit.

FIG. 20 is a flowchart illustrating a flow of processing according to the second embodiment.

FIG. 21 is a diagram illustrating a functional configuration of a multifunction apparatus according to a third embodiment.

FIG. 22 is a diagram illustrating a functional configuration of a document feature determination unit according to the third embodiment.

FIG. 23 is a diagram illustrating a functional configuration of a region separation processing unit according to the third embodiment.

FIG. 24 is a flowchart illustrating a flow of processing according to the third embodiment.

FIG. 25 is a diagram illustrating a functional configuration of a multifunction apparatus according to a fourth embodiment.

FIG. 26 is a diagram illustrating a functional configuration of a region separation processing unit according to the fourth embodiment.

FIG. 27 is a table for explaining processing executed by a region identification signal integration unit.

FIG. 28 is a table illustrating processing performed by a color correction unit, a black generation and under-color removal unit, a spatial filter processing unit, and a gradation reproduction processing unit in accordance with a region identification signal.

FIG. 29 is a flowchart illustrating a flow of processing according to the fourth embodiment.

FIG. 30 is a flowchart illustrating a flow of processing according to the fourth embodiment.

### DETAILED DESCRIPTION OF THE INVENTION

Hereinafter, embodiments of the present disclosure will be described with reference to the drawings. The embodiments to be described below are merely examples for describing the present disclosure, and the technical contents described in the claims are not limited to the following descriptions.

In region separation processing targeting a document in which character regions, photograph regions, and halftone dot regions are present together, in the related art, a region separation signal for an attention pixel has been determined based on image data of the attention pixel and several pixels ×several pixels surrounding the attention pixel.

However, in the known region separation processing, a determination related to identification of the region may be incorrect, and when image processing in a subsequent stage is performed based on an incorrectly determined region separation signal, a gap (processing gap) occurs between the processing that should have been applied based on a correctly determined region separation signal and the processing applied based on the incorrectly determination, making it impossible to obtain a high quality printing result.

In the present disclosure, a processing apparatus or the like that can reproduce a high quality printing result when printing a document in which character regions, photograph regions, halftone dot regions, and the like are mixed together is realized through the embodiments to be described below.

### 1 First Embodiment

A first embodiment is an embodiment in which the processing apparatus according to the present disclosure is applied to a multifunction apparatus 10 as an image processing apparatus. The multifunction apparatus 10 can realize, within a single housing, jobs related to copying, printing, scanning, facsimile, and email transmission, and the multifunction apparatus 10 is also an image forming apparatus that can generate image data by scanning a document and form (print) an image (color image or monochrome image) based on the image data.

### 1.1 Functional Configuration

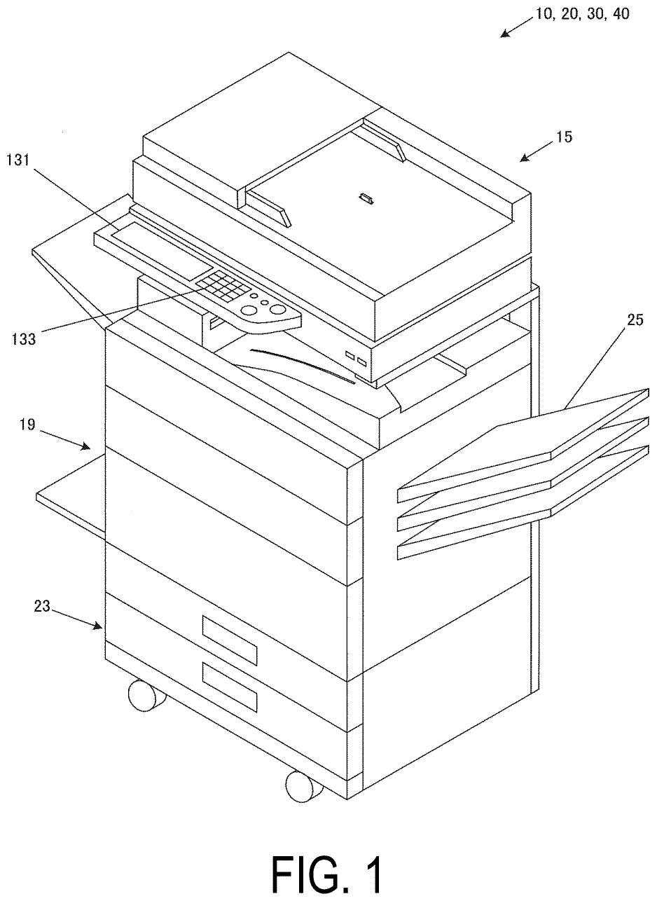

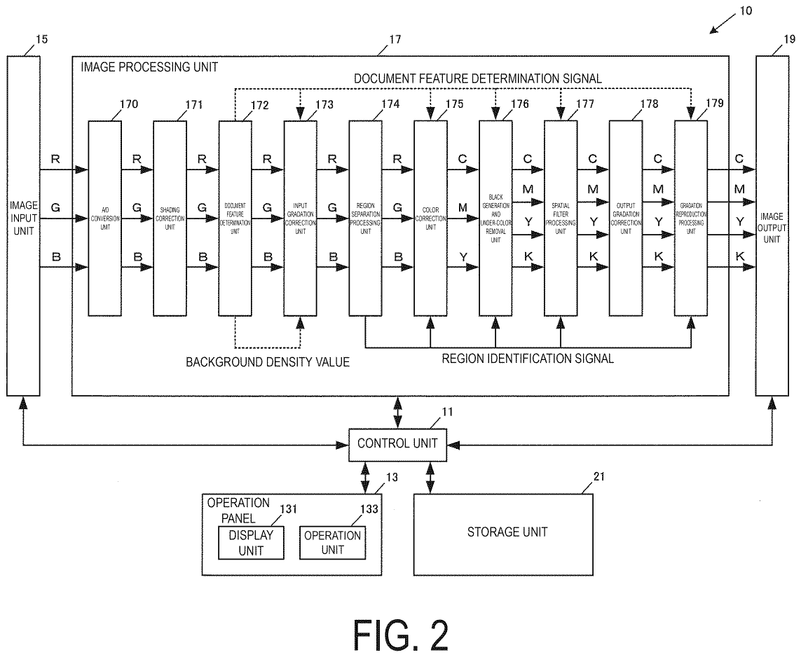

FIG. 1 is an appearance perspective view illustrating an overall configuration of the multifunction apparatus 10 according to the first embodiment. FIG. 2 is a functional configuration diagram of the multifunction apparatus 10.

The multifunction apparatus 10 includes a control unit 11, an operation panel 13, an image input unit 15, an image processing unit 17, an image output unit 19, and a storage unit 21.

The control unit 11 performs overall control of the multifunction apparatus 10. The control unit 11 can be implemented using one or more arithmetic devices such as a central processing unit (CPU) or a digital signal processor (DSP). By reading and executing various programs stored in the storage unit 21, the control unit 11 realizes various functions provided by the multifunction apparatus 10. The control unit 11 may also be implemented as a System on a Chip (SoC) having multiple functions among functions to be described below.

The operation panel 13 receives operation instructions for the multifunction apparatus 10 and displays various types of information. The operation panel 13 can be implemented, for example, using a display unit 131 and an operation unit 133. The display unit 131 and the operation unit 133 may be controlled by the control unit 11, or, when the operation panel 13 is provided with a control device that independently or integrally controls the display unit 131 and the operation unit 133, the control may be performed by the control device.

Here, the display unit 131 can be implemented, for example, using a display device such as a liquid crystal display (LCD), an organic electroluminescence (EL) display, or a micro LED display. The display unit 131 displays an operation screen corresponding to a state of the multifunction apparatus 10 (for example, a home screen that is not shown, or an execution screen or a setting screen related to matters of each job).

The operation unit 133 receives input of information from a user or the like. The operation unit 133 can be implemented, for example, using various input devices such as operation keys including hard keys or software keys, or buttons. The operation panel 13 can be implemented as a touch panel that allows information to be input via the display unit 131. When the operation panel 13 is implemented as a touch panel, the operation panel 13 can detect, for example, a touch, tap, or swipe operation that a user performs with respect to an object such as operation keys or operation buttons displayed through the display unit 131, and acquire coordinate information, pressure information, or the like on the touch panel. As an input scheme for the touch panel, a common input scheme such as a resistive film scheme, an infrared scheme, an electromagnetic induction scheme, or a capacitive scheme can be adopted.

The control unit 11 controls operations of the image input unit 15, the image processing unit 17, and the image output unit 19 based on the information input via the operation panel 13.

The image input unit 15 inputs, to the image processing unit 17, an analog signal (RGB signal) of RGB (R: red, G: green, B: blue) obtained by reading an image on a document, for example. Such an image input unit 15 can be implemented using a scanner of, for example, a charge coupled device (CCD) type or a contact image sensor (CIS) type, which includes a device that reads an image on a document, converts the read image into an electric signal, and quantizes and encodes the electric signal.

The image processing unit 17 outputs, to the image output unit 19, a digital signal of CMYK (C: cyan, M: magenta, Y: yellow, K: black) obtained by processing the analog signal input from the image input unit 15. A configuration of the image processing unit 17 will be described below.

The image output unit 19 outputs an image based on image data (digital signal) of the document input from the image processing unit 17. The image output unit 19 forms (prints) an image, for example, on a recording medium such as recording paper. In this case, the image output unit 19 functions as an image formation unit that forms an image. When the image output unit 19 functions as the image formation unit, the image output unit 19 can be implemented as a printing device such as a laser printer using an electrophotographic scheme. The image output unit 19 forms an image on a surface of the recording paper fed from a paper feed tray 23, and discharges the recording paper on which the image has been formed to a paper discharge tray 25. The image output unit 19 may also be a printing device using an inkjet scheme. Further, the image output unit 19 may be configured to directly output the image data (digital signal) as transmission data to an external information processing apparatus (not shown), or to output the image data as transmission data attached at the time of email transmission or the like.

The storage unit 21 is a storage device that stores various programs and various data required for an operation of the multifunction apparatus 10. The storage unit 21 can be implemented, for example, using a storage device such as a read only memory (ROM), random access memory (RAM), a solid state drive (SSD) that is a semiconductor memory, or a hard disk drive (HDD).

### 1.1.1 Image Processing Unit

Next, the image processing unit 17 will be described. The image processing unit 17 includes an analog/digital (A/D) conversion unit 170, a shading correction unit 171, a document feature determination unit 172, an input gradation correction unit 173, a region separation processing unit 174, a color correction unit 175, a black generation and under-color removal unit 176, a spatial filter processing unit 177, an output gradation correction unit 178, and a gradation reproduction processing unit 179.

One or more of the functional units may be implemented using an electric circuit or application specific integrated circuit (ASIC). Further, one or more arithmetic devices (such as CPUs or DSPs) may execute various programs to control the functional units, the image processing unit 17, and the image processing apparatus (multifunction apparatus 10), and when a control device that controls the functional units is provided in the image processing unit 17, control may be performed by such a control device.

The A/D conversion unit 170 converts the RGB signal (analog signal) input from the image input unit 15 into a digital signal (for example, a 10-bit digital signal). The converted RGB signal (digital signal) indicates, for example, pixel values of an R component, a G component, and a B component for each of pixels constituting the image. Further, by converting the analog signal into a digital signal, the image is represented as data, and image data based on the reading of the document is generated. The A/D conversion unit 170 outputs the converted RGB signal to the shading correction unit 171.

The shading correction unit 171 performs shading correction on the RGB signal input from the A/D conversion unit 170. The shading correction refers to a correction for removing various distortions that occur in an illumination system, an imaging system, or an image capturing system of the image input unit 15. The shading correction unit 171 may also perform adjustments of color balance or the like. Further, the shading correction unit 171 may convert the RGB signal input from the A/D conversion unit 170 into 8-bit image data while performing correction processing. The conversion processing from 10-bit to 8-bit image data may be performed by the document feature determination unit 172 or the input gradation correction unit 173 described below. The shading correction unit 171 outputs the RGB signal of the image data subjected to the correction processing or the conversion processing to the document feature determination unit 172.

The document feature determination unit 172 performs background density determination processing for determining a density of a background (a background density) of an image based on the RGB signal input from the shading correction unit 171, and document type determination processing for determining which type of document such as a character document, a printed photograph document, or a character and printed photograph mixed document the document corresponds to. The document feature determination unit 172 generates a document feature determination signal indicating a determination result of document type determination processing and outputs the document feature determination signal to the input gradation correction unit 173, the color correction unit 175, the black generation and under-color removal unit 176, the spatial filter processing unit 177, and the gradation reproduction processing unit 179. The input gradation correction unit 173, the color correction unit 175, the black generation and under-color removal unit 176, the spatial filter processing unit 177, and the gradation reproduction processing unit 179 perform image processing operations on the image data in accordance with the input document feature determination signal. Further, the document feature determination unit 172 generates a background density value indicating a processing result of the background density determination processing and outputs the background density value to the input gradation correction unit 173. A configuration of the document feature determination unit 172 will be described below.

The input gradation correction unit 173 performs input gradation correction on the RGB signal input from the document feature determination unit 172. The input gradation correction refers to image quality adjustment processing (input gradation correction processing) such as processing for removing background (density) or processing for adjusting contrast. The processing for removing background (density) is performed according to the background density value calculated by a background density determination unit 1724 of the document feature determination unit 172 and a determination result of the document type determination, thereby making the background density white. A method of background removal processing is not particularly limited, and for example, a method described in Japanese Patent Application Laid Open No. 2000-354167 or the like may be used to perform the background removal processing. In the background removal processing, a correction amount table corresponding to the background density value is selected and background removal processing is performed. When a histogram is created using a minimum value of each plane (each color component) of the background pixels, the correction amount table corresponding to the minimum value may be selected for all color components and the background removal processing may be performed. The input gradation correction unit 173 outputs the RGB signal after input gradation correction to the region separation processing unit 174.

The region separation processing unit 174 performs region separation processing on the RGB signal input from the input gradation correction unit 173. The region separation refers to processing for separating each pixel in an image based on the input RGB signal into one of a pixel belonging to an edge region, a pixel belonging to a halftone dot region, a pixel belonging to a photograph region, a pixel belonging to a background region, and the like. The region separation processing unit 174 may also perform a color determination for determining whether the region is either color or monochrome. Here, when the region is determined to be color in the edge region, the region can be separated as a color edge region, and when the region is determined to be monochrome in an edge region, the region can be separated as a black edge region. The region separation processing unit 174 according to the first embodiment performs region separation processing different from the known region separation processing. Details will be described below.

Further, the region separation processing unit 174 outputs a region identification signal as an identification signal indicating the result of the region separation processing to the color correction unit 175, the black generation and under-color removal unit 176, the spatial filter processing unit 177, and the gradation reproduction processing unit 179 based on a result of the region separation processing. Here, the region identification signal is an identification signal indicating, for example, to which region each pixel included in the image based on the RGB signal belongs.

The color correction unit 175 converts a color space of the image based on the RGB signal input from the region separation processing unit 174 into a CMY color space and performs color correction (color correction processing) in accordance with characteristics of the image output unit 19. For example, the color correction unit 175 performs processing for removing color muddiness based on spectral characteristics of the CMY color materials including unnecessary absorption components from the CMY signal, in order to achieve faithful color reproduction. The color correction unit 175 may perform different color corrections in accordance with the region identification signal input from the region separation processing unit 174. Different color corrections according to a result (region identification signal) of the region separation processing according to the first embodiment will be described below. The color correction unit 175 outputs the corrected CMY signal to the black generation and under-color removal unit 176.

The black generation and under-color removal unit 176 performs black generation processing for generating a K (black) signal from the CMY signal input from the color correction unit 175, and performs processing for generating a new CMY signal by subtracting the K (black) signal obtained through the black generation from an original CMY signal. As a result, a three-color digital signal of CMY is converted into a four-color digital signal of CMYK (a CMYK signal).

Here, as one example of the black generation processing performed by the black generation and under-color removal unit 176, a method of performing black generation using skeleton black and removing under-color is performed may be used. In this method, when input and output characteristics of a skeleton curve are y=f(x), input data are C, M, and Y, the output data are C′, M′, Y′, and K′, and a under color removal (UCR) rate is α (0<α<1), the data output by the black generation and under-color removal processing are expressed by the following equations:

$${K}^{′} = f ( min ( C , M , Y ) )$$

$${C}^{′} = C - α {K}^{′}$$

$${M}^{′} = M - α {K}^{′}$$

$${Y}^{′} = Y - α {K}^{′}$$

Here, the UCR rate (0<α<1) indicates whether CMY overlapping portions are replaced with K and to what extent CMY is reduced. The equations indicate that a K signal is generated in accordance with the smallest signal intensity among the signal intensities of CMY. The black generation and under-color removal unit 176 may perform different black generation and under-color removal processing in accordance with the region identification signal. Different black generation and under-color removal according to a result (region identification signal) of the region separation processing according to the first embodiment will be described below. The black generation and under-color removal unit 176 outputs the CMYK signal obtained by converting the CMY signal to the spatial filter processing unit 177.

The spatial filter processing unit 177 performs spatial filter processing using a digital filter on the CMYK signal input from the black generation and under-color removal unit 176. The spatial filter processing unit 177 corrects the spatial frequency characteristics of the image and prevents blurring or degradation of granularity of an output image in the image output unit 19. For example, the spatial filter processing unit 177 performs sharpness enhancement processing using a filter having a large degree of enhancement of high frequency components on a region separated as the edge region in the region separation processing performed by the region separation processing unit 174, in order to particularly improve the reproducibility of the lines or edges. Also, the spatial filter processing unit 177 performs low pass filter processing for removing input halftone dot components on a region separated as a halftone dot region in the region separation processing performed by the region separation processing unit 174. Details of different spatial filter processing in accordance with the result (region identification signal) of the region separation processing according to the first embodiment will be described below. The spatial filter processing unit 177 outputs the CMYK signal after spatial filter processing to the output gradation correction unit 178.

The output gradation correction unit 178 performs output gradation correction processing on the CMYK signal input from the spatial filter processing unit 177 in accordance with the characteristics of the image output unit 19, and outputs the CMYK signal after the output gradation correction processing to the gradation reproduction processing unit 179.

The gradation reproduction processing unit 179 performs gradation reproduction processing (halftone processing) on the CMYK signal input from the output gradation correction unit 178. For example, the gradation reproduction processing unit 179 performs processing for improving, in particular, the reproducibility of lines or edges on a region separated as the edge region in the region separation processing performed by the region separation processing unit 174. Here, as the processing for improving the reproducibility of lines or edges, the gradation reproduction processing unit 179 performs, for example, binarization processing or multi-value processing using a high resolution screen suitable for reproduction of high frequency components in the image output unit 19.

Further, the gradation reproduction processing unit 179 may perform gradation reproduction processing (halftone generation) so that the image of the region can be finally separated into pixels and the gradation of each pixel can be appropriately reproduced, on a region separated as the halftone dot region in the region separation processing performed by the region separation processing unit 174. Further, the gradation reproduction processing unit 179 may perform binarization processing or multi-value processing using a screen emphasizing gradation reproducibility in the image output unit 19, on a region separated as the photograph region (photographic print region) in the region separation processing performed by the region separation processing unit 174. Different gradation reproduction processing in accordance with the result (region identification signal) of the region separation processing according to the first embodiment will be described below. The gradation reproduction processing unit 179 may perform binarization processing or multi-value processing using the same screen on both the region separated as the halftone dot region and the region separated as the photograph region.

Incidentally, the reason why the spatial filter processing unit 177 performs the low pass filter processing on the region separated as the halftone dot region in the region separation processing unit 174 is to suppress moire generated between the image data having a certain periodic characteristic due to halftones of the image of the document and periodic processing such as dithering. Therefore, when the gradation reproduction processing unit 179 performs, for example, error diffusion processing, that is, when the gradation reproduction processing unit 179 does not perform the periodic processing such as dithering, the spatial filter processing unit 177 does not need to perform the low pass filter processing. When the spatial filter processing unit 177 does not perform the low pass filter processing, spatial filter processing unit 177 may perform the sharpness enhancement processing. Thus, the spatial filter processing unit 177 may switch processing to be executed in accordance with the processing in the gradation reproduction processing unit 179.

The image processing unit 17 outputs the CMYK signal processed by the gradation reproduction processing unit 179. The processing related to the output of the image data may be performed by the gradation reproduction processing unit 179, or may be realized by the control unit 11 acquiring the CMYK signal processed by the gradation reproduction processing unit 179. In this case, the control unit 11 or the gradation reproduction processing unit 179 may output the image data (CMYK signal) to the image output unit 19, or may temporarily store the image data by outputting the image data as a file to the storage unit 21. In this case, the control unit 11 may read the image data stored in the storage unit 21 at a predetermined timing for executing image formation and output the read image data to the image output unit 19, thereby outputting an image based on the image data.

### 1.1.1.1 Details of Document Feature Determination Unit

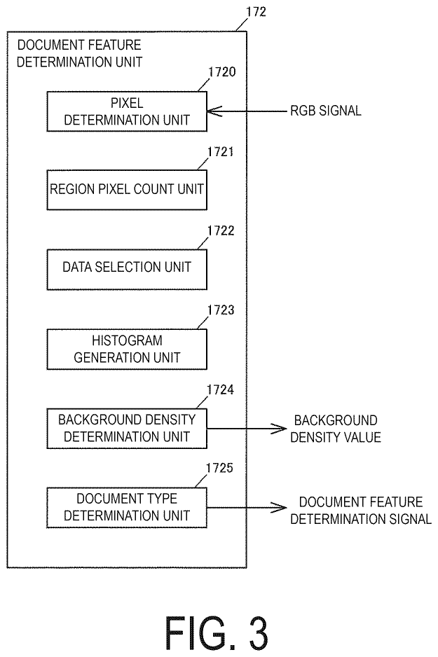

Next, details of the document feature determination unit 172 will be described. FIG. 3 is a diagram illustrating a functional configuration of the document feature determination unit 172. The document feature determination unit 172 includes a pixel determination unit 1720, a region pixel count unit 1721, a data selection unit 1722, a histogram generation unit 1723, a background density determination unit 1724, and a document type determination unit 1725.

The pixel determination unit 1720 performs region pixel determination processing for classifying each pixel of the image based on the RGB signal input from the shading correction unit 171 into a background pixel, a photograph pixel (continuous gradation pixel), a character pixel, or a halftone dot pixel. In the following description, pixels classified into the background pixel, photograph pixel, character pixel, or halftone dot pixel may be referred to as a “region pixel”.

Here, an algorithm for classification into region pixels is not particularly limited, and an existing method can be used, for example. In this method, the region pixel determination processing is performed through the following steps (1) to (8).
(1) Calculate a minimum density value and a maximum density value in an n×m (for example, 7 pixels×7 pixels) pixel block including an attention pixel.
(2) Calculate a maximum density difference using the calculated minimum density value and maximum density value.
(3) Calculate total density complexity, which is a sum of absolute values of the density differences between the attention pixel and adjacent pixels (for example, a sum of values calculated for a main scanning direction and a sub scanning direction).
(4) Compare the calculated maximum density difference with a maximum density difference threshold, and compare the calculated total density complexity with a total density complexity threshold.
(5) When the maximum density difference<maximum density difference threshold and the total density complexity<total density complexity threshold, determine that the attention pixel belongs to a background/photograph region.
(6) When the above conditions are not satisfied, determine that the attention pixel belongs to a character/halftone dot region.
(7) For the pixel determined to belong to the background/photograph region, when the attention pixel satisfies a condition of maximum density difference<background/photographic paper determination threshold, determine that the attention pixel is a background pixel, and when the condition is not satisfied, determine that the attention pixel is a photograph pixel.
(8) For the pixel determined to belong to the character/halftone dot region, when the attention pixel satisfies a condition of total density complexity<(maximum density difference×character/halftone determination threshold), determine that the attention pixel is a character pixel, and when the condition is not satisfied, determine that the attention pixel is a halftone dot pixel.

The region pixel determination processing may be performed using image data obtained by pre-scanning, or may be performed using image data temporarily stored in a storage device such as the storage unit 21.

The region pixel count unit 1721 performs region pixel count processing for counting the number of classified pixels (region pixels) for each type of region pixel (for the region pixel of the background pixel, photograph pixel, character pixel, and halftone dot pixel) based on the result of the region pixel determination processing in the pixel determination unit 1720. The region pixel count unit 1721 also performs counting of the classification results of the halftone line number.

The data selection unit 1722 performs region selection processing for separating the region of the image based on the RGB signal input from the shading correction unit 171 into a target region that is a target of histogram generation processing of the histogram generation unit 1723 and an exclusion region excluded from the target of the histogram generation processing. In the first embodiment, the histogram generation processing is not performed on all pixels of the image based on the input RGB signal, but is performed on the pixels other than some pixels.

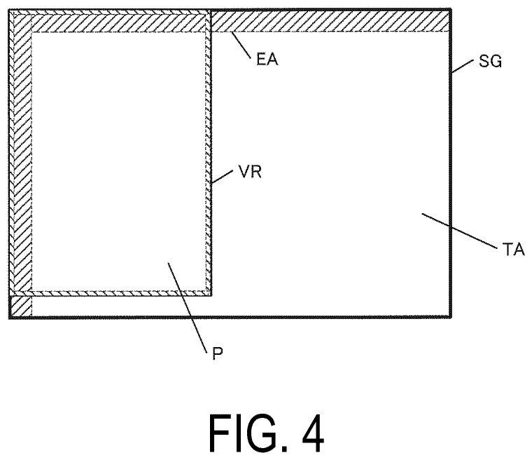

Here, a method of setting the exclusion region to be excluded from the target of histogram generation will be described with reference to FIG. 4. FIG. 4 is a schematic diagram illustrating a state in which a document P to be read is placed on a document table SG when the image input unit 15 reads the document.

The shading correction unit 171 performs processing for removing various distortions occurring in the illumination system, imaging system, and image capturing system of the image input unit 15 on image data generated by the image input unit 15 reading the document. However, such processing does not necessarily perform appropriate correction for all regions of the image data. For example, when the document is read by the image input unit 15, a region located at an edge portion of the document table SG (an edge region of the document) may result in a relatively dark signal.

Therefore, in the first embodiment, as illustrated in FIG. 4, a region corresponding to a predetermined range at the edge portion of the document table SG is set as an exclusion region EA excluded from the target of the histogram generation, and other regions are set as target regions TA for histogram generation.

The exclusion region EA is not limited to the example illustrated in FIG. 4 and may be set appropriately, and for example, a portion of a void region VR of the document P adjacent to an edge portion of a glass surface of the document table SG at the time of reading may be included in the exclusion region EA. The void region VR refers to a region in which nothing is printed, and is present with a width of several millimeters (for example, about 4 mm) from an edge portion (peripheral portion) of a document printed or copied by a printer.

Returning again to FIG. 3, the histogram generation unit 1723 extracts, as attention pixels, pixels belonging to a region determined to be a background pixel in the region pixel determination processing of the pixel determination unit 1720 and determined to be a target region for histogram generation in the region selection processing of the data selection unit 1722, in the image based on the RGB signal input from the shading correction unit 171, and performs histogram generation processing (minimum value histogram generation processing).

Specifically, the histogram generation unit 1723 performs comparison for each plane (for each color component) with respect to the attention pixel, calculates a minimum value among color components of the attention pixel. The histogram generation unit 1723 adds 1 to a frequency of a density division to which the calculated minimum value belongs among a plurality of preset density divisions. In the first embodiment, the number of density divisions of the histogram is set to 32, such that the density divisions are set as a first density division and a second density division in order from the smaller pixel value (density value), and a division with the greatest pixel value (density value) is set as a 32nd density division. Further, in the first embodiment, since the image based on the RGB signal is targeted, the closer the pixel value (density value) is to “0” (the smaller the density value is), the darker the actual density becomes, and the closer the pixel value (density value) is to “255” (the larger the density value is), the lighter (paler) the density becomes.

The reason why a histogram is generated using the minimum value among color components is that, by taking the density value of the darkest color component of the background (the color component whose density value is a minimum value) as the background density, and applying the correction amount table for the density value to all color components and performing background removal processing, it is possible to perform background removal also on the color components other than the darkest color component.

The background density determination unit 1724 performs background density determination processing for determining the background density. The background density determination unit 1724 outputs the background density value indicating the result of the background density determination to the input gradation correction unit 173.

The document type determination unit 1725 determines a document type of overall document by comparing the number of region pixels counted based on the region pixel count processing of the region pixel count unit 1721 with respective thresholds corresponding to a predetermined background region, photograph region, character region, and halftone dot region.

For example, when the detection accuracy is high in the order of the character region, the halftone dot region, and the photograph region and a ratio of pixels in the character region is 30% or more of the total number of pixels, the document type determination unit 1725 determines the document type to be a character document. Further, when a ratio of pixels in the halftone dot region is 20% or more of the total number of pixels, the document type determination unit 1725 determines the document type to be a halftone document (printed photograph document). Further, when a ratio of pixels of the photograph region is 10% or more of the total number of pixels, the document type determination unit 1725 determines the document type to be a photographic print document. When both the ratio of the character region and the ratio of the halftone dot region are equal to or greater than their respective thresholds, the document type determination unit 1725 determines the document type to be a character/halftone document (character printed photograph document). When both the ratio of the character region and the ratio of the photograph region are equal to or greater than their respective thresholds, the document type determination unit 1725 determines the document type to be a character/photograph document (character photographic paper document).

The document feature determination unit 172 outputs a document feature determination signal indicating the result of the determination of the document type to the input gradation correction unit 173, the color correction unit 175, the black generation and under-color removal unit 176, the spatial filter processing unit 177, and the gradation reproduction processing unit 179.

### 1.1.1.2 Details of Region Separation Processing Unit

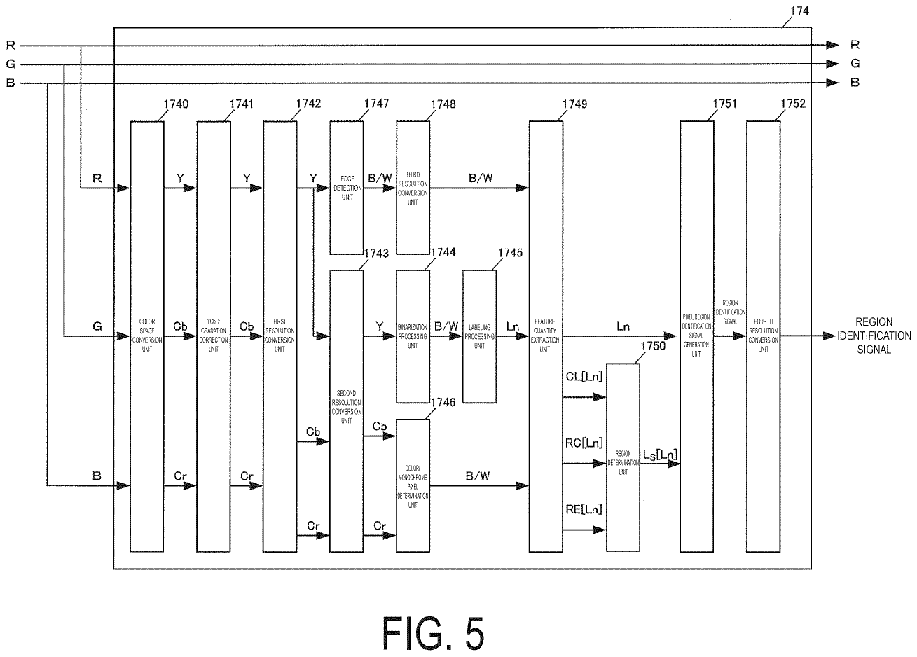

Next, details of the region separation processing unit 174 will be described. FIG. 5 is a diagram illustrating a functional configuration of the region separation processing unit 174.

The region separation processing unit 174 includes a color space conversion unit 1740, a YCbCr gradation correction unit 1741, a first resolution conversion unit 1742, a second resolution conversion unit 1743, a binarization processing unit 1744, a labeling processing unit 1745, a color/monochrome pixel determination unit 1746, an edge detection unit 1747, a third resolution conversion unit 1748, a feature quantity extraction unit 1749, a region determination unit 1750, a pixel region identification signal generation unit 1751, and a fourth resolution conversion unit 1752.

The color space conversion unit 1740 converts a color space of the image based on the corrected RGB signal input from the input gradation correction unit 173 into a signal of the YCbCr color space, and outputs the signal to the YCbCr gradation correction unit 1741.

The YCbCr gradation correction unit 1741 performs gradation correction on the image based on the YCbCr signal input from the color space conversion unit 1740. For example, the YCbCr gradation correction unit 1741 performs correction processing on the Y signal in accordance with the background density value input from the document feature determination unit 172 so that separation between the background and the non-background portion is easily performed in resolution conversion and binarization processing in a subsequent stage, thereby making the background density white. It is not always necessary to perform the correction processing on the Cb signal and Cr signal. The YCbCr gradation correction unit 1741 outputs the YCbCr signal after gradation correction to the first resolution conversion unit 1742. Incidentally, since background removal has been performed by the gradation correction in the input gradation correction unit 173, when the separation between the background and the non-background portion can be appropriately performed, it is not necessarily required to perform background removal in the YCbCr gradation correction unit 1741.

The first resolution conversion unit 1742 performs resolution conversion processing on the image based on the YCbCr signal input from the YCbCr gradation correction unit 1741. For example, the first resolution conversion unit 1742 converts an image (data) having a resolution of 600 dpi into an image (data) having a resolution of 300 dpi with a magnification ratio of 50%. As a conversion method, for example, a conversion method such as bilinear interpolation or bicubic interpolation can be used. Further, the image (data) may be divided into blocks of 2×2 pixels, and an average value of four pixels within each block may be output so that the image data is converted into an image of 300 dpi. The first resolution conversion unit 1742 outputs the Y signal after resolution conversion to the edge detection unit 1747, and outputs the YCbCr signal after resolution conversion to the second resolution conversion unit 1743.

The second resolution conversion unit 1743 performs resolution conversion processing on the image based on the YCbCr signal input from the first resolution conversion unit 1742. For example, the second resolution conversion unit 1743 converts an image (data) having a resolution of 300 dpi into an image (data) having a resolution of 150 dpi with a magnification ratio of 50%. As a conversion method, for example, a conversion method such as bilinear interpolation or bicubic interpolation can be used. Further, the image (data) may be divided into blocks of 2×2 pixels, and an average value of four pixels within each block may be output so that the image data is converted into an image of 150 dpi. The second resolution conversion unit 1743 outputs the Y signal after resolution conversion to the binarization processing unit 1744, and outputs the CbCr signal after resolution conversion to the color/monochrome pixel determination unit 1746.

The binarization processing unit 1744 performs binarization processing on the Y signal input from the second resolution conversion unit 1743. Commonly, when the binarization processing is performed based on a predetermined threshold, the brighter side becomes binary data “1” and the darker side becomes binary data “0”, but the binarization processing unit 1744 according to the first embodiment converts the brighter side binary data to “0” and the darker side binary data to “1”. The binarization processing unit 1744 outputs the binarized image after binarization processing as a binary signal (B/W) to the labeling processing unit 1745.

The labeling processing unit 1745 performs labeling processing for assigning a label number to a region in which “1” of the binary data input from the binarization processing unit 1744 is connected (continuous) (which may hereinafter be referred to as a connected region). The labeling processing unit 1745 functions as an acquisition unit, assigns the label number Ln=“0” to binary data “0” corresponding to a background prior to binarization processing, assigns label numbers in the order in which connected regions having a binary value of “1” are found, and outputs, as connection region information, the label number data (Ln) assigned to each pixel to the feature quantity extraction unit 1749.

The color/monochrome pixel determination unit 1746 determines whether each pixel is either a color pixel or a monochrome pixel based on the CbCr signal input from the second resolution conversion unit 1743. For example, when a sum of a square of a value of the Cb signal (component) and a square of a value of the Cr signal (component) of each pixel is equal to or greater than a predetermined threshold, the color/monochrome pixel determination unit 1746 determines that the pixel is a color pixel, and when the sum is smaller than the predetermined threshold, the color/monochrome pixel determination unit 1746 determines that the pixel is a monochrome pixel. In order to speed up the processing related to color/monochrome pixel determination, the color/monochrome pixel determination unit 1746 may determine that the pixel is a color pixel when a sum of the Cb signal (component) value and the Cr signal (component) value is equal to or greater than a predetermined threshold, and determine that the pixel is a monochrome pixel when the sum is smaller than the predetermined threshold. A color/monochrome binary image in which a value “1” is assigned when the determination result indicates a color pixel, and a value “0” is assigned when the determination result indicates a monochrome pixel is output as a binary signal (B/W) to the feature quantity extraction unit 1749.

The edge detection unit 1747 performs edge detection processing on the Y signal input from the first resolution conversion unit 1742. For example, the edge detection unit 1747 outputs an edge binary image as a binary signal (B/W) in which a value “1” is assigned to a pixel determined to be an edge pixel and a value “0” is assigned to a pixel determined not to be an edge pixel, to the third resolution conversion unit 1748.

The third resolution conversion unit 1748 performs resolution conversion processing on the edge binary image based on the binary signal input from the edge detection unit 1747. For example, the third resolution conversion unit 1748 converts an image (data) having a resolution of 300 dpi into an image (data) having a resolution of 150 dpi with a magnification ratio of 50%. As a conversion method, for example, a conversion method such as a nearest neighbor method can be used. Further, for example, the image (data) may be divided into blocks of 2×2 pixels, and when even one of the four pixels in the block has a value “1”, a value “1” indicating an edge pixel is output, and when all of the four pixels in the block have a value “0”, a value “0” is output, thereby converting the resolution from resolution of 300 dpi to resolution of 150 dpi.

The feature quantity extraction unit 1749 functions as an extraction unit and performs processing for extracting a feature quantity of each label based on the label number data input from the labeling processing unit 1745, the color/monochrome binary image input from the color/monochrome pixel determination unit 1746, and the edge binary image input from the edge detection unit 1747 via the third resolution conversion unit 1748. First, the feature quantity extraction unit 1749 extracts, for each label number Ln having a value of “1” or more, the total number of pixels, the number of color pixels, and the number of edge pixels. The total number of pixels for each label number is extracted by adding 1 to the value CL[Ln] in correspondence to the label number Ln of the label number data of each pixel. Further, the number of color pixels for each label number is extracted by adding 1 to a value CC[Ln] in correspondence to the label number Ln of the label number data when the pixel is a color pixel (binary signal value=“1”) in the color/monochrome binary image. Further, the number of edge pixels for each label number is extracted by adding 1 to a value CE[Ln] in correspondence to the label number Ln when the pixel is an edge pixel (binary signal value=“1”) in the edge binary image.

Next, the feature quantity extraction unit 1749 calculates, for each label number, a color pixel ratio RC[Ln] and an edge pixel ratio RE[Ln]. The color pixel ratio RC[Ln] for each label number can be obtained by dividing the number of color pixels CC[Ln] by the total number of pixels CL[Ln]. The edge pixel ratio RE[Ln] for each label number can be obtained by dividing the number of edge pixels CE[Ln] by the total number of pixels CL[Ln].

The feature quantity extraction unit 1749 outputs, for each label number, the total number of pixels CL[Ln], the color pixel ratio RC[Ln], and the edge pixel ratio RE[Ln] to the region determination unit 1750.

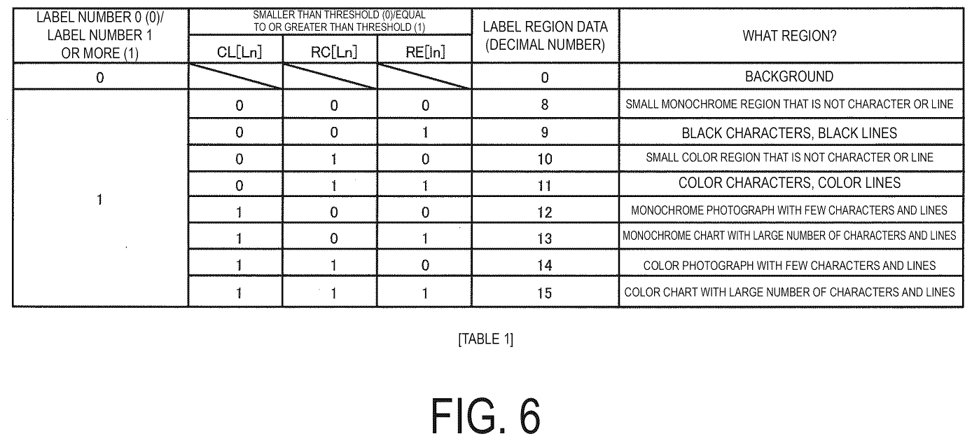

The region determination unit 1750 functions as a first determination unit and determines which region each label represents by referring to Table 1 illustrated in FIG. 6, based on the total number of pixels CL[Ln], the color pixel ratio RC[Ln], and the edge pixel ratio RE[Ln] input from the feature quantity extraction unit 1749, and generates 4-bit region data.

For example, when the label number is “0”, the region determination unit 1750 sets the most significant bit of the four bits to “0”; when the label number is “1” or more, the region determination unit 1750 sets the most significant bit of the four bits to “1”. Also, for each label number, when the total number of pixels CL[Ln] is smaller than the predetermined threshold, the region determination unit 1750 sets the second bit from the most significant bit among the four bits to “0”, when the total number of pixels CL[Ln] is equal to or greater than the predetermined threshold, the region determination unit 1750 sets the second bit from the most significant bit among the four bits to “1”.

The region determination unit 1750, for each label number, sets the third bit from the most significant bit among the four bits to “0” when the color pixel ratio RC[Ln] is smaller than the predetermined threshold, and to “1” when the color pixel ratio RC[Ln] is equal to or greater than the predetermined threshold. Further, for each label number, when the edge pixel ratio RE[Ln] is smaller than the predetermined threshold, the region determination unit 1750 sets the least significant bit among the four bits to “0”, and when the edge pixel ratio RE[Ln] is equal to or greater than the predetermined threshold, the region determination unit 1750 sets the least significant bit among the four bits to “1”.

The region determination unit 1750 outputs, to the pixel region identification signal generation unit 1751, label region data Ls[Ln] determined by referring to Table 1 based on the generated 4-bit region data.

For example, when the label number is “0”, the region determination unit 1750 determines that the corresponding pixel is a pixel belonging to the background region, and outputs “0” as the label region data Ls[Ln] to the pixel region identification signal generation unit 1751.

Further, when the label number is equal to or greater than “1”, the total number of pixels CL[Ln] is smaller than the predetermined threshold, the color pixel ratio RC[Ln] is smaller than the predetermined threshold, and the edge pixel ratio RE[Ln] is smaller than the predetermined threshold, the region determination unit 1750 determines that the corresponding pixel is a pixel belonging to a small monochrome region that is not a character or a line, and outputs “8” as the label region data Ls[Ln] to the pixel region identification signal generation unit 1751.

Further, when the label number is equal to or greater than “1”, the total number of pixels CL[Ln] is smaller than the predetermined threshold, the color pixel ratio RC[Ln] is smaller than the predetermined threshold, and the edge pixel ratio RE[Ln] is equal to or greater than a predetermined threshold, the region determination unit 1750 determines that the corresponding pixel is a pixel belonging to a region of a black character or black line, and outputs “9” as the label region data Ls[Ln] to the pixel region identification signal generation unit 1751.

Further, when the label number is equal to or greater than “1”, the total number of pixels CL[Ln] is smaller than the predetermined threshold, the color pixel ratio RC[Ln] is equal to or greater than a predetermined threshold, and the edge pixel ratio RE[Ln] is smaller than the predetermined threshold, the region determination unit 1750 determines that the corresponding pixel is a pixel belonging to a small color region that is not a character or a line, and outputs “10” as the label region data Ls[Ln] to the pixel region identification signal generation unit 1751.

Further, when the label number is equal to or greater than “1”, the total number of pixels CL[Ln] is smaller than the predetermined threshold, the color pixel ratio RC[Ln] is equal to or greater than a predetermined threshold, and the edge pixel ratio RE[Ln] is equal to or greater than a predetermined threshold, the region determination unit 1750 determines that the corresponding pixel is a pixel belonging to a region of a color character or color line, and outputs “11” as the label region data Ls[Ln] to the pixel region identification signal generation unit 1751.

Further, when the label number is equal to or greater than “1”, the total number of pixels CL[Ln] is equal to or greater than a predetermined threshold, the color pixel ratio RC[Ln] is smaller than the predetermined threshold, and the edge pixel ratio RE[Ln] is smaller than the predetermined threshold, the region determination unit 1750 determines that the corresponding pixel is a pixel belonging to a region of a monochrome photograph with few characters and lines, and outputs “12” as the label region data Ls[Ln] to the pixel region identification signal generation unit 1751.

Further, when the label number is equal to or greater than “1”, the total number of pixels CL[Ln] is equal to or greater than a predetermined threshold, the color pixel ratio RC[Ln] is smaller than the predetermined threshold, and the edge pixel ratio RE[Ln] is equal to or greater than a predetermined threshold, the region determination unit 1750 determines that the corresponding pixel is a pixel belonging to a region of a monochrome chart with a large number of characters and lines, and outputs “13” as the label region data Ls[Ln] to the pixel region identification signal generation unit 1751.

Further, when the label number is equal to or greater than “1”, the total number of pixels CL[Ln] is equal to or greater than a predetermined threshold, the color pixel ratio RC[Ln] is equal to or greater than a predetermined threshold, and the edge pixel ratio RE[Ln] is smaller than the predetermined threshold, the region determination unit 1750 determines that the corresponding pixel is a pixel belonging to a region of a color photograph with few characters and lines, and outputs “14” as the label region data Ls[Ln] to the pixel region identification signal generation unit 1751.

Further, when the label number is equal to or greater than “1”, the total number of pixels CL[Ln] is equal to or greater than a predetermined threshold, the color pixel ratio RC[Ln] is equal to or greater than a predetermined threshold, and the edge pixel ratio RE[Ln] is equal to or greater than a predetermined threshold, the region determination unit 1750 determines that the corresponding pixel is a pixel belonging to a region of a color chart with a large number of characters and lines, and outputs “15” as the label region data Ls[Ln] to the pixel region identification signal generation unit 1751.

In this case, for example, the label number, the attribute of the determined region (region identification signal), and information related to image processing to be applied in accordance with the region identification signal may be stored as region information in association with each other, and the content of the region information may be displayed on the display unit 131 of the operation panel 13. The configuration of the display screen displayed on the operation panel 13 is not particularly limited but, for example, a label position on the document of pixels (connected region) that is a target of image processing may be displayed to be identified, or, for example, an input reception means for receiving a user's input instruction to change the image processing to be applied in accordance with the region identification signal can be displayed.

Incidentally, for the predetermined threshold of the color pixel ratio RC[Ln] and the predetermined threshold of the edge pixel ratio RE[Ln], different threshold values may be used depending on whether the total number of pixels CL[Ln] is equal to or greater than, or smaller than, the predetermined threshold.

Returning again to FIG. 5, the pixel region identification signal generation unit 1751 generates, as a region identification signal, the label region data Ls[Ln] input from the region determination unit 1750 for each label number Ln of each pixel, and outputs the label region data Ls[Ln] to the fourth resolution conversion unit 1752.

The fourth resolution conversion unit 1752 converts the region identification signal representing an attribute of a (connected) region expressed at a resolution of 150 dpi, which is input from the pixel region identification signal generation unit 1751, into a region identification signal representing an attribute of a (connected) region expressed at a four times higher resolution of 600 dpi, and outputs the region identification signal. The fourth resolution conversion unit 1752 converts the resolution by generating a region identification signal for 4×4 pixels from the region identification signal of each pixel. Accordingly, the region identification signal has the same resolution as the corrected RGB signal input from the input gradation correction unit 173, and the RGB signal and the region identification signal are associated with each other on a pixel by pixel basis based on pixel position information, and are output to the color correction unit 175, the black generation and under-color removal unit 176, the spatial filter processing unit 177, and the gradation reproduction processing unit 179.

### 1.1.1.3 Details of Color Correction Unit, Black Generation and Under-Color Removal Unit, Spatial Filter Processing Unit, and Gradation Reproduction Processing Unit

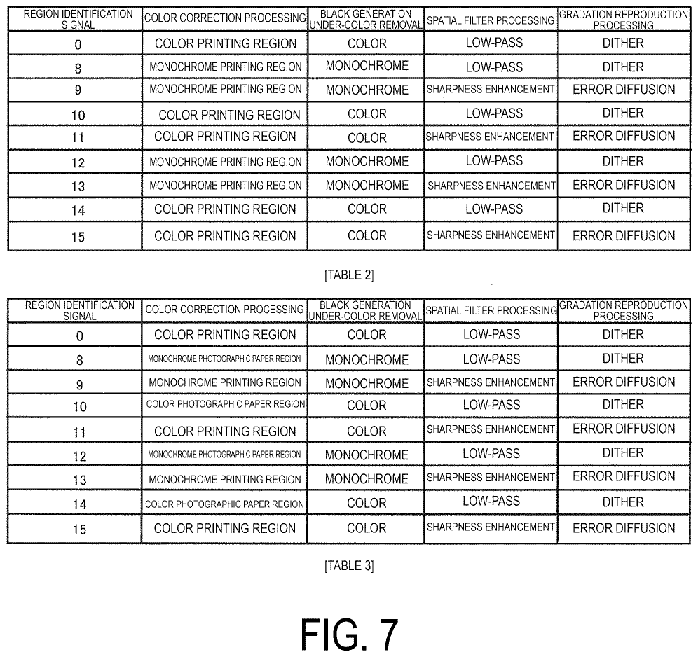

Next, the details of the color correction unit 175, the black generation and under-color removal unit 176, the spatial filter processing unit 177, and the gradation reproduction processing unit 179 will be described with reference to Tables 2 (and 3) in FIG. 7.

As shown in Table 2, the color correction unit 175, the black generation and under-color removal unit 176, the spatial filter processing unit 177, and the gradation reproduction processing unit 179 according to the first embodiment function as a generation unit that generates the image data (CMYK signal) output to the image output unit 19 by applying different (predetermined) image processing in accordance with the region identification signal input from the region separation processing unit 174.

The color correction unit 175 performs processing for converting the color space of the image based on the RGB signal input from the region separation processing unit 174 into the CMY color space, but the color correction unit 175 performs correction, as monochrome output processing, on pixels belonging to the region identification signals “8”, “9”, “12”, and “13” indicating monochrome regions, using a setting in which the three signals of CMY output the same value, performs correction using a setting for color output processing on pixels belonging to signals other than the region identification signals “8”, “9”, “12”, and “13”, and outputs the corrected CMY signal to the black generation and under-color removal unit 176.

The black generation and under-color removal unit 176 performs black generation processing for generating a K signal from the CMY signal input from the color correction unit 175 and processing for generating a new CMY signal obtained by subtracting the K signal obtained by the black generation from the original CMY signal, but performs processing in which the above-described UCR rate α is set to 1, as the monochrome output processing, on the pixels belonging to the region identification signals “8”, “9”, “12”, and “13” indicating monochrome regions, and performs processing in which the UCR rate α is set to a predetermined value (0<α<1), as the color output processing, on the pixels belonging to signals other than “8”, “9”, “12”, and “13”.

The spatial filter processing unit 177 performs spatial filter processing using a digital filter on the image based on the CMYK signal input from the black generation and under-color removal unit 176, but performs sharpness enhancement processing for enhancing edge reproducibility of characters or lines on pixels belonging to region identification signals “9”, “11”, “13”, and “15” indicating regions of characters or lines or chart regions including a large number of characters or lines, and performs smoothing processing (for example, a low pass filter) for preventing degradation of granularity on pixels belonging to signals other than “9”, “11”, “13”, and “15”.

The gradation reproduction processing unit 179 performs gradation reproduction processing on the image based on the CMYK signal input from the output gradation correction unit 178, but performs error diffusion processing on the pixels belonging to region identification signals “9”, “11”, “13”, and “15” indicating the regions of the characters or lines or the chart regions including a large number of characters or lines, and performs dithering processing or the like for preventing degradation of granularity on the pixels belonging to signals other than “9”, “11”, “13”, and “15”.

Incidentally, the color correction unit 175, the black generation and under-color removal unit 176, the spatial filter processing unit 177, and the gradation reproduction processing unit 179 may perform processing with settings different from those of Table 2 in accordance with the document feature determination signal input from the document feature determination unit 172 (document type determination unit 1725). For example, when the document feature determination signal indicates that the document is a character document, halftone document, or character/halftone document, processing is performed with the same settings as in Table 2, when the signal indicates that the document is a photographic print document or a character/photograph document (character photographic paper document), the color correction unit 175 may perform processing with a different setting shown in Table 3 of FIG. 7. Here, for example, the region identification signals “12” and “14” indicate that the region to which the pixel belongs is a photographic print region, but even small regions that are not characters or lines are likely to be photographic print regions. Therefore, the color correction unit 175 performs correction using a monochrome photographic print region setting (setting for a monochrome photographic paper region: a setting in which three signals of CMY output the same value) different from the monochrome printing region setting related to region identification signals “9” and “13” on pixels belonging to region identification signals “8” and “12”. Also, the color correction unit 175 performs correction using a color photographic print region setting different from a color printing region setting related to region identification signals “11” and “15” on pixels belonging to region identification signals “10” and “14”. Although in Table 3, the processing executed by the black generation and under-color removal unit 176, the spatial filter processing unit 177, and the gradation reproduction processing unit 179 is the same as that shown in Table 2, the units may perform processing based on separate settings for photographic print regions on pixels belonging to region identification signals “8”, “10”, “12”, and “14”, similar to the color correction unit 175.

### 1.2 Processing Flow

### 1.2.1 Overall Processing

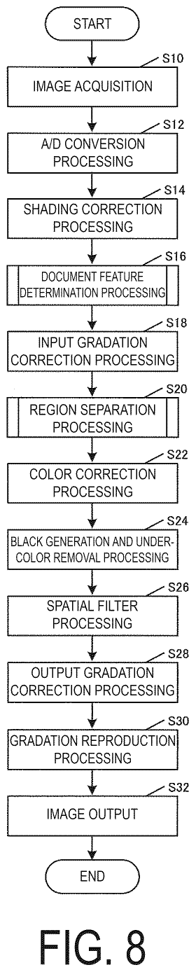

Next, overall processing of the multifunction apparatus 10 according to the first embodiment will be described with reference to the flowchart of FIG. 8. The processing illustrated in FIG. 8 is processing executed by the control unit 11 operating as each functional unit by reading a program stored in the storage unit 21. The processing illustrated in FIG. 8 will be described as processing that is executed by receiving, via the operation panel 13, an instruction from the user to execute a job for reading a document, such as a copy job or a scan job.

The control unit 11 controls the image input unit 15 to read an image on a document, thereby acquiring an analog signal (RGB signal) based on the read image (step S10).

Subsequently, the control unit 11 controls each functional unit of the image processing unit 17 to perform image processing on the read image (input image).

The A/D conversion unit 170 performs A/D conversion for converting the RGB signal of the analog signal based on the read image into an RGB signal of a digital signal (step S12).

The shading correction unit 171 performs shading correction processing on the image based on the RGB signal input from the A/D conversion unit 170 (step S14). In this case, the shading correction unit 171 may also perform color balance adjustment and conversion processing into 8 bit image data.

The document feature determination unit 172 performs background density determination processing and document type determination processing as document feature determination processing on the RGB signal input from the shading correction unit 171 (step S16).

The input gradation correction unit 173 performs input gradation correction on the RGB signal input from the document feature determination unit 172 (step S18).

Subsequently, the region separation processing unit 174 performs region separation processing on the RGB signal input from the input gradation correction unit 173 (step S20).

The color correction unit 175 converts the color space of the image based on the RGB signal input from the region separation processing unit 174 into the CMY color space, and performs the color correction processing (step S22).

The black generation and under-color removal unit 176 performs black generation and under-color removal processing on the CMY signal input from the color correction unit 175 (step S24).

The spatial filter processing unit 177 performs spatial filter processing on the CMYK signal input from the black generation and under-color removal unit 176 (step S26).

The output gradation correction unit 178 performs output gradation correction processing on the CMYK signal input from the spatial filter processing unit 177 (step S28).

The gradation reproduction processing unit 179 performs gradation reproduction processing on the CMYK signal input from the output gradation correction unit 178 (step S30).

The control unit 11 or the gradation reproduction processing unit 179 outputs the CMYK signal after gradation reproduction processing to the image output unit 19 (step S32). As described above, the processing for outputting the CMYK signal after gradation reproduction processing to the image output unit 19 may be executed by the control unit 11. Further, the control unit 11 or the gradation reproduction processing unit 179 may store image data based on the CMYK signal in the storage unit 21. Moreover, by controlling the image output unit 19, the control unit 11 may output and display the image based on the output CMYK signal (image data), for example, on the display unit 131 of the operation panel 13.

### 1.2.2 Document Feature Determination Processing

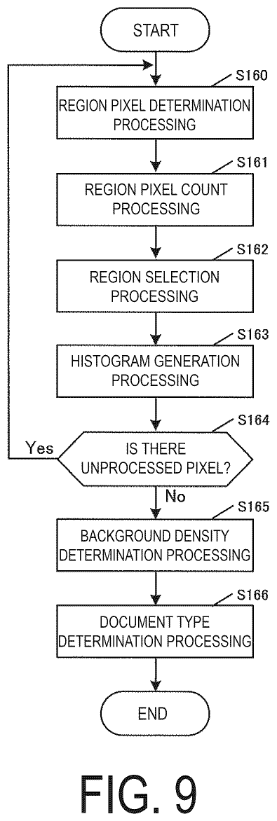

Next, document feature determination processing performed by the document feature determination unit 172 will be described with reference to the flowchart in FIG. 9.

First, the pixel determination unit 1720 performs region pixel determination processing for classifying each pixel of the image based on the RGB signal input from the shading correction unit 171 into one of a background pixel, a photograph pixel (continuous gradation pixel), a character pixel, and a halftone dot pixel (step S160).

Next, the region pixel count unit 1721 performs region pixel count processing for counting the number of classified pixels (region pixels) for each type of region pixel (for the region pixel of the background pixel, photograph pixel, character pixel, and halftone dot pixel) based on the result of the region pixel determination processing in the pixel determination unit 1720 (step S161).

The data selection unit 1722 performs region selection processing for separating the region of the image based on the RGB signal input from the shading correction unit 171 into a target region that is a target of the histogram generation processing of the histogram generation unit 1723 and an exclusion region excluded from the target of the histogram generation processing (step S162).

The histogram generation unit 1723 extracts, as attention pixels, pixels belonging to a region determined to be a background pixel in the region pixel determination processing of the pixel determination unit 1720 and determined to be a target region for histogram generation in the region selection processing of the data selection unit 1722, in the image based on the RGB signal input from the shading correction unit 171, and performs histogram generation processing (minimum value histogram generation processing) (step S163).

The document feature determination unit 172 determines whether the processing related to steps S160 to S163 has been performed on all the pixels (step S164). When it is determined that unprocessed pixels remain, the document feature determination unit 172 performs the processing from step S160 on the unprocessed pixels (step S164: Yes→step S160).

On the other hand, when it is determined that the processing related to steps S160 to S163 has been completed for all pixels, the background density determination unit 1724 performs background density determination processing for determining the background density (step S164: No→step S165).

The document type determination unit 1725 determines a document type of overall document by comparing the number of region pixels counted based on the region pixel count processing of the region pixel count unit 1721 with respective thresholds corresponding to the predetermined background region, photograph region, character region, and halftone dot region, and ends the processing (step S166).

### 1.2.3 Region Separation Processing

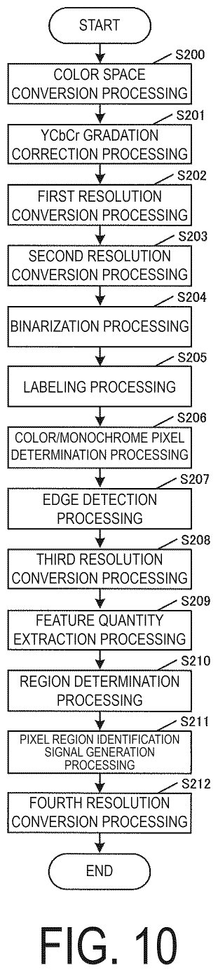

Next, the region separation processing performed by the region separation processing unit 174 will be described with reference to the flowchart in FIG. 10.

First, the color space conversion unit 1740 performs color space conversion processing, in which the color space of the image based on the corrected RGB signal input from the input gradation correction unit 173 is converted into a signal in the YCbCr color space (step S200).

The YCbCr gradation correction unit 1741 performs gradation correction processing on the image based on the YCbCr signal input from the color space conversion unit 1740 (step S201).

The first resolution conversion unit 1742 performs resolution conversion processing on the image based on the YCbCr signal input from the YCbCr gradation correction unit 1741 (step S202). For example, the first resolution conversion unit 1742 converts an image (data) having a resolution of 600 dpi into an image (data) having a resolution of 300 dpi with a magnification ratio of 50%.

The second resolution conversion unit 1743 performs resolution conversion processing on the image based on the YCbCr signal input from the first resolution conversion unit 1742 (step S203). For example, the second resolution conversion unit 1743 converts an image (data) having a resolution of 300 dpi into an image (data) having a resolution of 150 dpi with a magnification ratio of 50% (step S203).

The binarization processing unit 1744 performs binarization processing on the Y signal input from the second resolution conversion unit 1743 (step S204).

The labeling processing unit 1745 performs labeling processing for assigning a label number to a region in which “1” of the binary data input from the binarization processing unit 1744 is connected (continuous) (step S205).

The color/monochrome pixel determination unit 1746 performs color/monochrome pixel determination processing for determining whether each pixel is a color pixel or a monochrome pixel based on the CbCr signal input from the second resolution conversion unit 1743 (step S206).

The edge detection unit 1747 performs edge detection processing on the Y signal input from the first resolution conversion unit 1742 (step S207).

The third resolution conversion unit 1748 performs resolution conversion processing on the edge binary image based on the binary signal input from the edge detection unit 1747 (step S208). For example, the third resolution conversion unit 1748 converts an image (data) having a resolution of 300 dpi into an image (data) having a resolution of 150 dpi with a magnification ratio of 50% (step S208).

The feature quantity extraction unit 1749 performs feature quantity extraction processing for each label, based on the label number data input from the labeling processing unit 1745, the color/monochrome binary image input from the color/monochrome pixel determination unit 1746, and the edge binary image input through the third resolution conversion unit 1748 from the edge detection unit 1747 (step S209).

The region determination unit 1750 performs region determination processing for determining the label region data Ls[Ln] based on each label number, the total number of pixels CL[Ln] for each label number, the color pixel ratio RC[Ln], and the edge pixel ratio RE[Ln] (step S210).

The pixel region identification signal generation unit 1751 performs pixel region identification signal generation processing for generating, as a region identification signal, the label region data Ls[Ln] input from the region determination unit 1750 for the label number Ln of each pixel (step S211).

The fourth resolution conversion unit 1752 performs resolution conversion processing for converting the region identification signal at a resolution of 150 dpi input from the pixel region identification signal generation unit 1751 into a region identification signal at a four times higher resolution of 600 dpi and ends the processing (step S212).

### 1.3 Operational Example

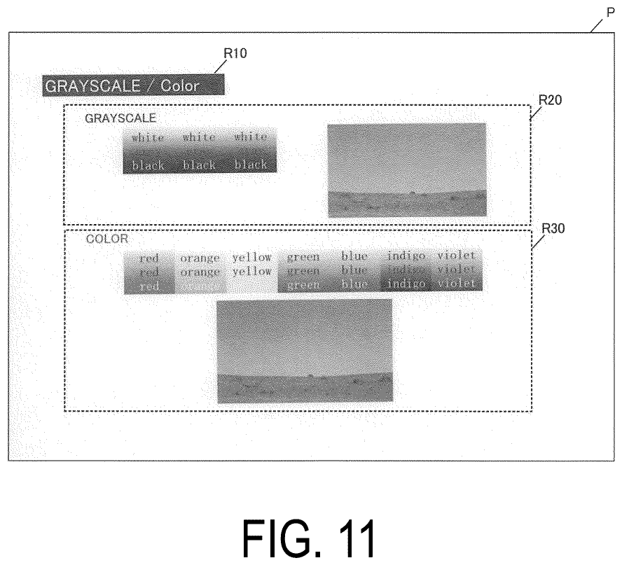

Next, an operational example according to the first embodiment will be described. FIG. 11 is a diagram illustrating an example of an image before being processed by the processing (image P before processing) device according to the first embodiment. The image P before processing is, for example, a color image having a resolution of 600 dpi. For convenience of description, the color image P before processing is represented in grayscale in FIG. 11.

The image P before processing includes a region R10 in which white outline characters (GRAYSCALE/Color) are formed on a black background, a region R20 including a character string (GRAYSCALE), a character string formed on a background in which words white, gray, and black are expressed in a grayscale gradation, and a monochrome photograph region, and a region R30 including a character string (COLOR), a character string region formed on a background in which words representing colors (red, orange, yellow, green, blue, indigo, and violet) are expressed in each color gradation, and a color photograph region.

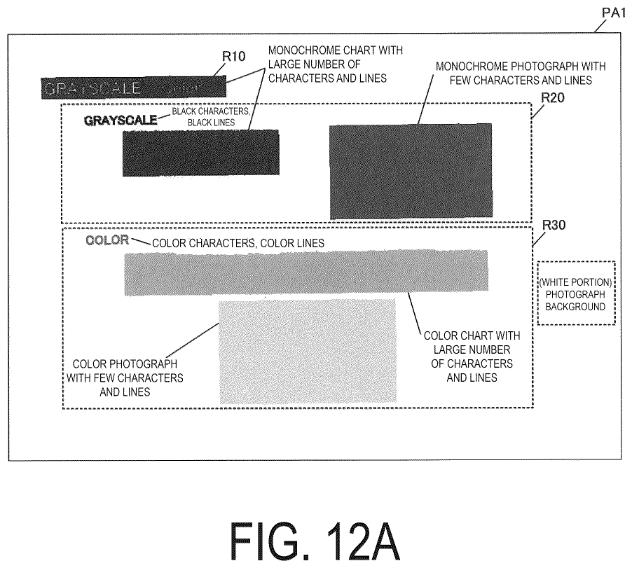

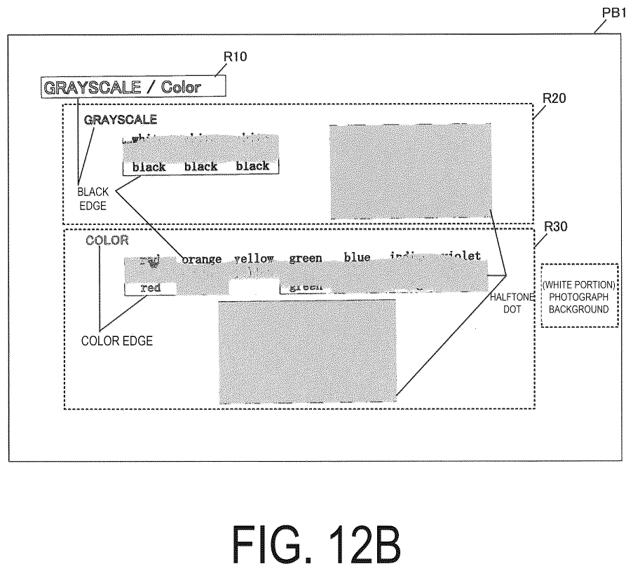

FIG. 12A is a diagram illustrating an example of the result of the region separation processing according to the first embodiment with respect to the image P before processing illustrated in FIG. 11. Further, FIG. 12B is a diagram illustrating an example of a result of the known region separation processing for performing region separation processing for the attention pixel based on image data of each attention pixel and several pixels×several pixels of the image data around the attention pixel.

In a processed image PA1 illustrated in FIG. 12A, the region R10 and a character string region formed on a background in which the character strings white, gray, and black included in the region R20 are expressed in grayscale gradation are determined to be monochrome charts with a large number of characters and lines (region identification signal “13”). Further, the monochrome photograph region included in the region R20 is determined to be a monochrome photograph with few characters and lines (region identification signal “12”). Further, the character string (GRAYSCALE) is determined to be black characters or black lines (region identification signal “9”).

Additionally, a character string region formed on the background in which the character strings representing the colors (red, orange, yellow, green, blue, indigo, and violet) included in the region R30 are expressed in respective color gradations and is determined to be a color chart with a large number of characters and lines (region identification signal “15”), and the color photograph region is determined to be a color photograph with few characters and lines (region identification signal “14”). Further, the character string (COLOR) is determined to be a color character or color line (region identification signal “11”).

On the other hand, in a processed image PB1 illustrated in FIG. 12B, pixels on outlines of the character string (GRAYSCALE) included in the regions R10 and R20 are determined to be black edges. Pixels on outlines of the character string (COLOR) included in the region R30 are determined to be color edges. Further, the monochrome photograph region included in the region R20 and the color photograph region included in the region R30 are both determined to be halftone dots. However, the pixels along the outlines of characters in the character string region included in the region R20 expressed in grayscale gradation and formed on the background and the character string region included in the region R30 expressed in color gradation are formed on the background are not always determined to be black edges or color edges and are determined to be halftone dots. Even in a single character, a black edge or color edge and a halftone dot are mixed.

In the known region separation processing illustrated in FIG. 12B, the image (region) on the document is separated into one of the regions of black edge, color edge, halftone dot, or background, whereas in the region separation processing according to the first embodiment illustrated in FIG. 12A, the image is separated into one of regions of a monochrome chart with a large number of characters and lines (region identification signal “13”), a monochrome photograph with few characters and lines (region identification signal “12”), black characters or black lines (region identification signal “9”), a color chart with a large number of characters and lines (region identification signal “15”), a color photograph with few characters and lines (region identification signal “14”), color characters or color lines (region identification signal “11”), or background. Although the region separation processing operations illustrated in FIGS. 12A and 12B are examples of processing, the region separation processing according to the first embodiment demonstrates that there is no unnatural switching of regions, and it is possible to achieve region separation processing with higher accuracy in comparison with the known region separation processing.

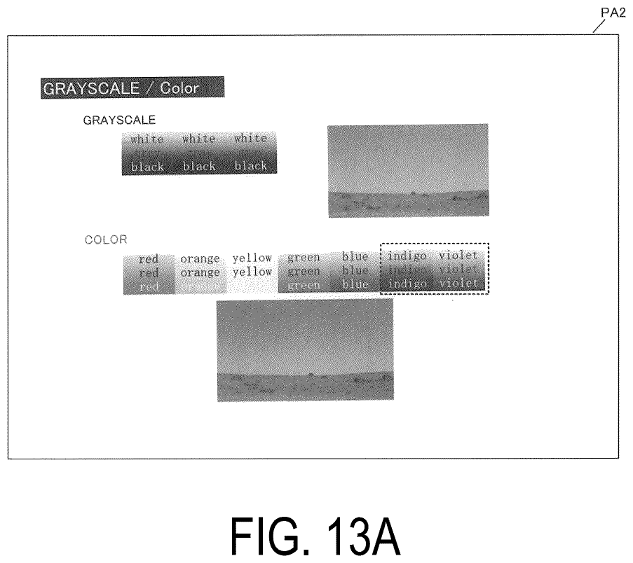

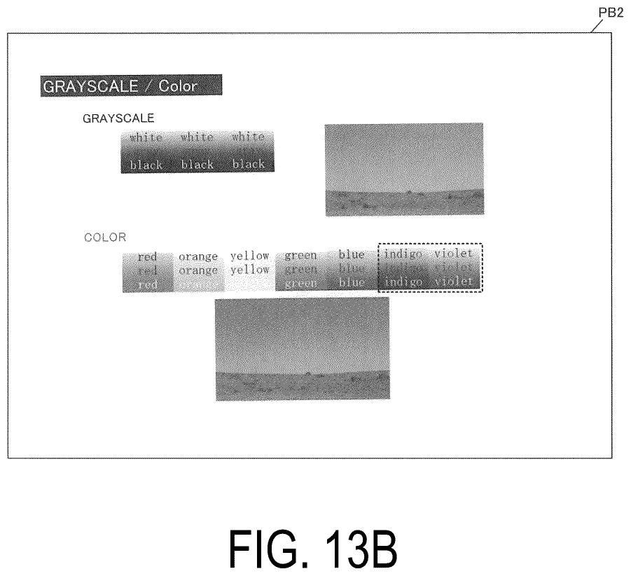

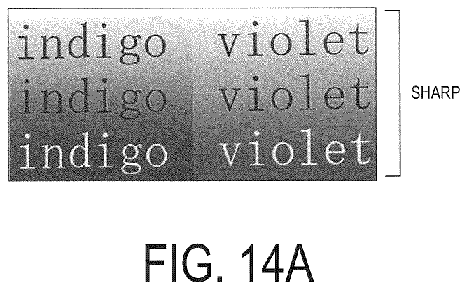

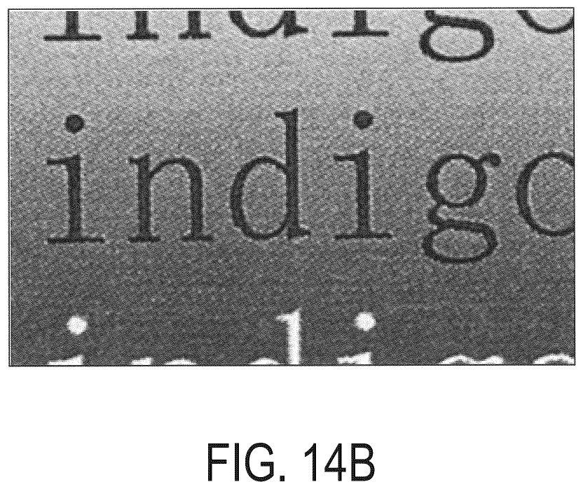

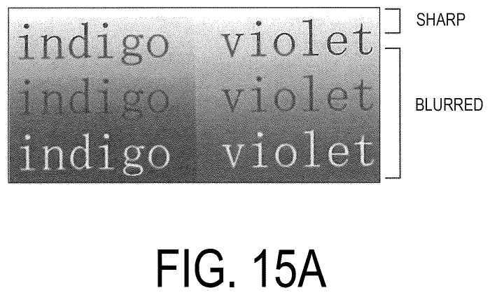

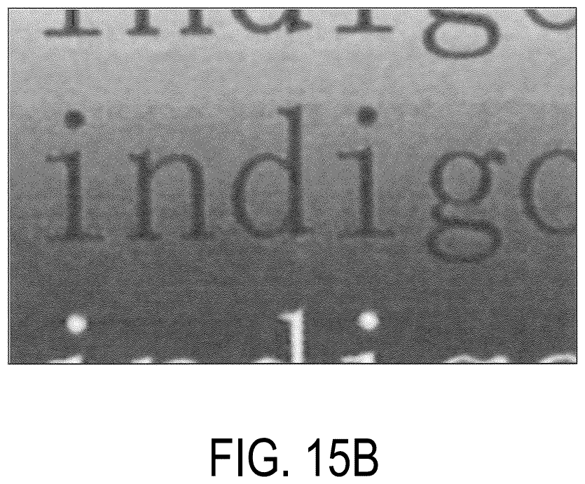

Next, FIG. 13A is a diagram illustrating an example of a result of performing image processing in a subsequent stage (color correction, black generation and under-color removal, spatial filter processing, and gradation reproduction processing) after the region separation processing according to the first embodiment. FIG. 13B is a diagram illustrating an example of the result of performing the image processing in a subsequent stage after the known region separation processing. Further, FIGS. 14A and 14B are enlarged views of the portions enclosed by the dotted frames in a processed image PA2 illustrated in FIG. 13A, and FIGS. 15A and 15B are enlarged views of the portions enclosed by the dotted frames in a processed image PB2 illustrated in FIG. 13B.

As shown in the processed image PA2 of FIG. 13A and the enlarged views of FIGS. 14A and 14B, when the processing according to the first embodiment is performed, for example, contours of the character strings forming the character string region of the region R30 are expressed clearly overall, and it can be seen that the image (character string) is reproduced with high accuracy without any processing gap occurring.

On the other hand, as shown in the processed image PB2 of FIG. 13B and in the enlarged views of FIGS. 15A and 15B, when processing of the related art is performed, for example, the contours of the character strings forming the character string region of the region R30 has middle and lower character strings reproduced in a blurred manner among three character strings, and a processing gap occurs for the image that has undergone region separation between the upper side in which an uppermost character string is expressed clearly, and the lower side in which the uppermost character string is expressed in a blurred manner.

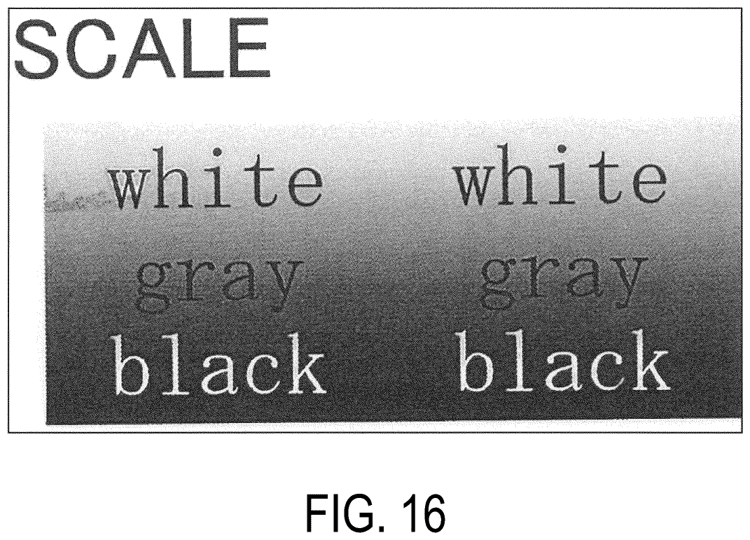

FIG. 16 is a diagram illustrating another example of the result of performing the region separation processing according to the first embodiment, the image processing in a subsequent stage (color correction, black generation and under-color removal, spatial filter processing, and gradation reproduction processing), and is an enlarged view of a character string region portion of the region R20 illustrated in FIG. 11.

In the first embodiment, it is possible to perform output in black (K) single color for the entire connected region of a monochrome chart with a large number of characters and lines. Accordingly, in the example of the processing result illustrated in FIG. 16, image formation using toner related to CMY components is not performed; the entire region can be represented only by the K component, and therefore, an amount of toner consumption related to the CMY components can be reduced.

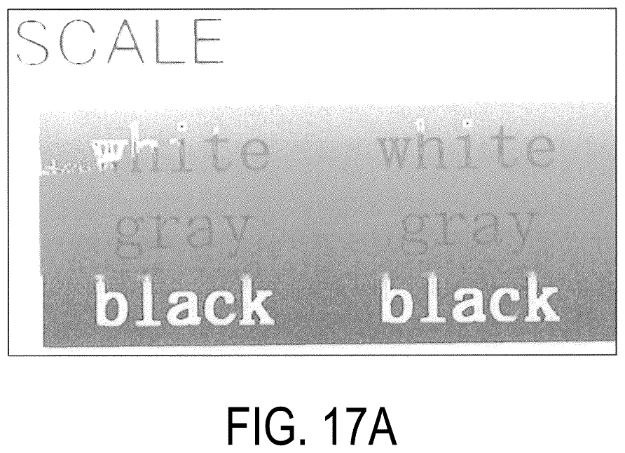

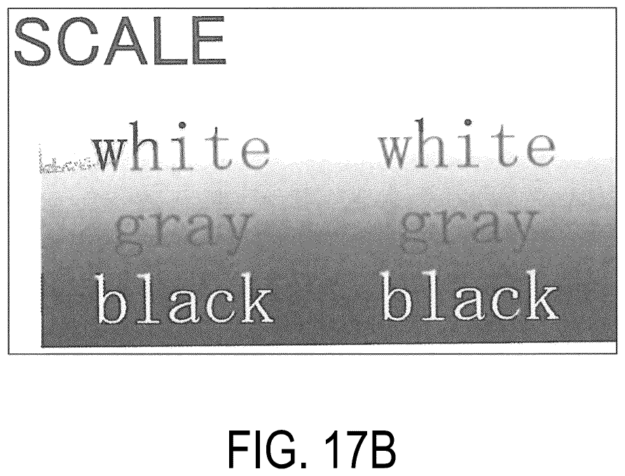

Meanwhile, FIGS. 17A and 17B show examples of processing results of performing image processing in a subsequent stage after the known region separation processing. FIG. 17A is a diagram illustrating an image formed with toner related to CMY components, in which the black edge portion includes no CMY components and portions other than the black edge are represented with toner related to the CMY components. FIG. 17B is a diagram illustrating an image formed with toner related to the K component, in which the black edge portion has a large amount of the K component and portions other than the black edge are also represented with toner related to the K component. In the processing example illustrated in FIGS. 17A and 17B, toners related to the CMY components are consumed in addition to the K component, resulting in an increased amount of toner consumption related to the CMY components.

Thus, in the first embodiment, based on labeling information in which labels are assigned to connected regions in which a plurality of pixels are connected, the feature quantities of each label including the pixel count, edge pixel count, and color pixel count for each connected region are extracted, the edge pixel ratio and the color pixel ratio for each connected region are calculated from the extracted label feature quantities, an attribute of each region is determined from the pixel count, edge pixel ratio, and color pixel ratio for each connected region, and appropriate image processing is applied in accordance with the region identification signal assigned based on the attribute of the region, thereby performing optimal image processing on each region (each pixel group) without the appearance of any processing gap.

Further, in the first embodiment, since a monochrome connected region can be represented entirely using only the K component without using toners related to the CMY components, it is possible to reduce the amount of toner consumption related to the CMY components.

### 2 Second Embodiment

### 2.1 Functional Configuration

A multifunction apparatus 20 according to the second embodiment includes a region separation processing unit 274 instead of the region separation processing unit 174 of the image processing unit 17 in the first embodiment. Portions having the same configuration as those in the first embodiment are denoted by the same reference numerals, and description thereof is omitted.

### 2.1.1 Image Processing Unit

### 2.1.1.1 Details of Region Separation Processing Unit

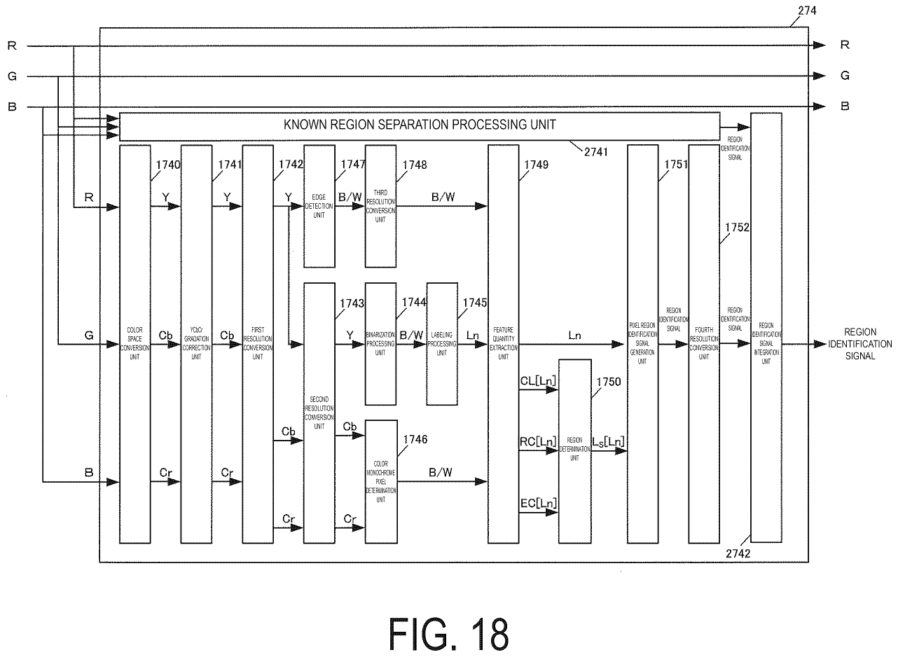

FIG. 18 is a diagram illustrating a functional configuration of the region separation processing unit 274 according to the second embodiment. The region separation processing unit 274 includes a known region separation processing unit 2741 and a region identification signal integration unit 2742, in addition to the color space conversion unit 1740, the YCbCr gradation correction unit 1741, the first resolution conversion unit 1742, the second resolution conversion unit 1743, the binarization processing unit 1744, the labeling processing unit 1745, the color/monochrome pixel determination unit 1746, the edge detection unit 1747, the third resolution conversion unit 1748, the feature quantity extraction unit 1749, the region determination unit 1750, the pixel region identification signal generation unit 1751, and the fourth resolution conversion unit 1752.

The known region separation processing unit 2741 functions as a second determination unit, and outputs a region identification signal indicating a black edge region and other regions (color edge region, halftone dot region, photograph region, and background region) through the known region separation processing for performing region separation processing for each attention pixel based on image data of each attention pixel and several pixels×several pixels of the image data around the attention pixel in accordance with the known region separation processing. The known region separation processing unit 2741 outputs “0” as the region identification signal indicating pixels belonging to the black edge region and “1” as the region identification signal indicating pixels belonging to other regions to the region identification signal integration unit 2742. The processing of the known region separation processing unit 2741 may be the same as the region pixel determination processing of the pixel determination unit 1720 in the document feature determination unit 172 according to the first embodiment.

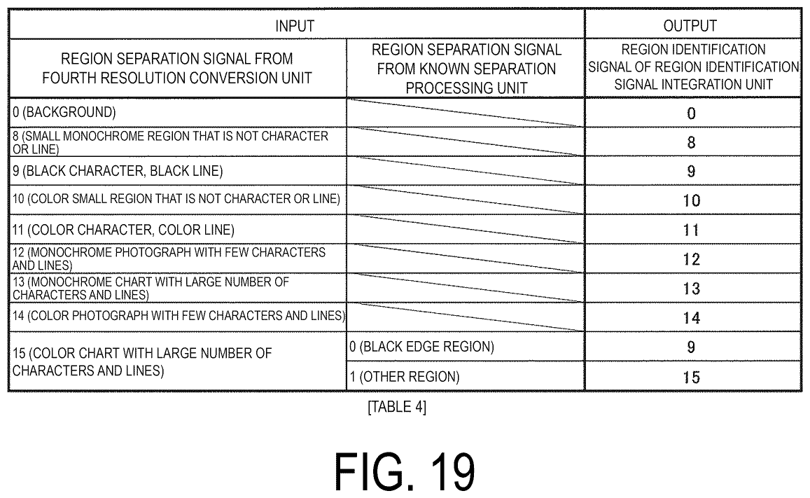

As shown in Table 4 of FIG. 19, the region identification signal integration unit 2742 integrates the region identification signal from the fourth resolution conversion unit 1752 with the region identification signal from the known region separation processing unit 2741, and outputs an integrated region identification signal. For example, the region identification signal integration unit 2742 outputs the region identification signal as is when the region identification signal input from the fourth resolution conversion unit 1752 is “0”, “8”, “9”, “10”, “11”, “12”, “13”, or “14”. On the other hand, when the region identification signal input from the fourth resolution conversion unit 1752 is “15” and the region identification signal input from the known region separation processing unit 2741 is “0”, the region identification signal integration unit 2742 outputs the region identification signal “9” and when the region identification signal input from the known region separation processing unit 2741 is “1”, the region identification signal integration unit 2742 outputs the region identification signal “15”.

### 2.1.1.2 Details of Color Correction Unit, Black Generation and Under-Color Removal Unit, Spatial Filter Processing Unit, and Gradation Reproduction Processing Unit

The color correction unit 175, the black generation and under-color removal unit 176, the spatial filter processing unit 177, and the gradation reproduction processing unit 179 according to the second embodiment perform different processing in accordance with the region identification signal input from the region separation processing unit 274, as shown in Table 2.

In the second embodiment, when the region identification signal input from the fourth resolution conversion unit 1752 is “15” and the region identification signal input from the known region separation processing unit 2741 is “0”, the region identification signal integration unit 2742 outputs the region identification signal “9”, and when the region identification signal input from the known region separation processing unit 2741 is “1”, the region identification signal integration unit 2742 outputs the region identification signal “15”, and therefore, it is possible to perform black single color output for black characters or black lines in the color chart with a large number of characters and lines.

### 2.2 Processing Flow

Since overall processing and document feature determination processing in the second embodiment can be performed in the same manner as in the first embodiment, description thereof is omitted.

### 2.2.1 Region Separation Processing

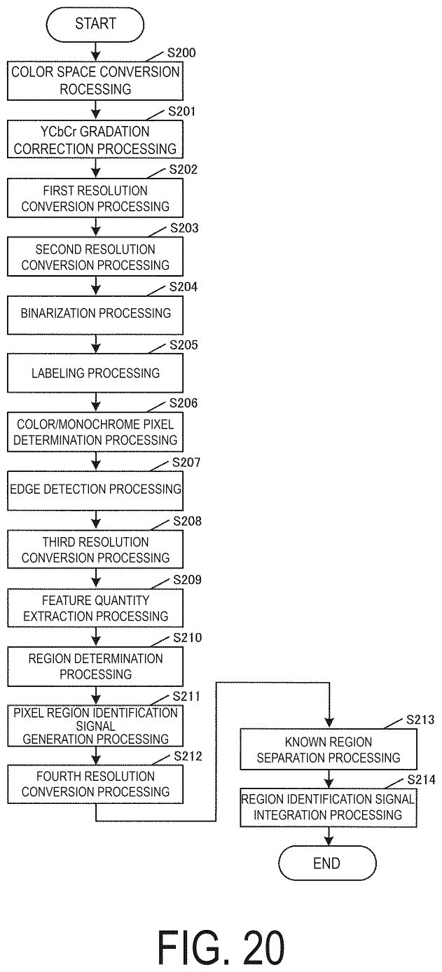

Next, region separation processing performed by the region separation processing unit 274 according to the second embodiment will be described with reference to a flowchart of FIG. 20. Since processing related to steps S200 to S212 illustrated in FIG. 20 can be performed in the same manner as the processing described in FIG. 10, description thereof is omitted.

In step S213, the known region separation processing unit 2741 performs region separation processing through the known region separation processing for performing region separation processing for each attention pixel based on the image data of each attention pixel and several pixels×several pixels of the image data around the attention pixel.

Next, the region identification signal integration unit 2742 performs processing for integrating the region identification signal input from the fourth resolution conversion unit 1752 with the region identification signal input from the known region separation processing unit 2741, outputs the integrated region identification signal, and ends the processing (step S214).

In the second embodiment, it is possible to perform output in black (K) single color for the black edge regions in a color chart with a large number of characters and lines. Since the spatial filter processing unit 177 can perform sharpness enhancement processing for enhancing the reproducibility of edges of characters or lines on other regions of the color chart including a large number of characters or lines, as described in the first embodiment, and the gradation reproduction processing unit 179 can perform error diffusion processing on the other regions, the same processing as that for the black edges of the color chart with a large number of characters and lines can be performed except for the color correction unit 175 and the black generation and under-color removal unit 176.

As described above, according to the second embodiment, since it is possible to integrate the region identification signal from the fourth resolution conversion unit with the region identification signal from the known region separation processing unit and output the integrated region identification signal, it is possible to perform output in black (K) single color output for black characters or black lines in the color chart with a large number of characters and lines, and to further reduce an amount of toner consumption related to the CMY components while suppressing a region separation gap compared with that in the known region separation processing, in addition to the effects of the first embodiment.

### 3 Third Embodiment

### 3.1 Functional Configuration

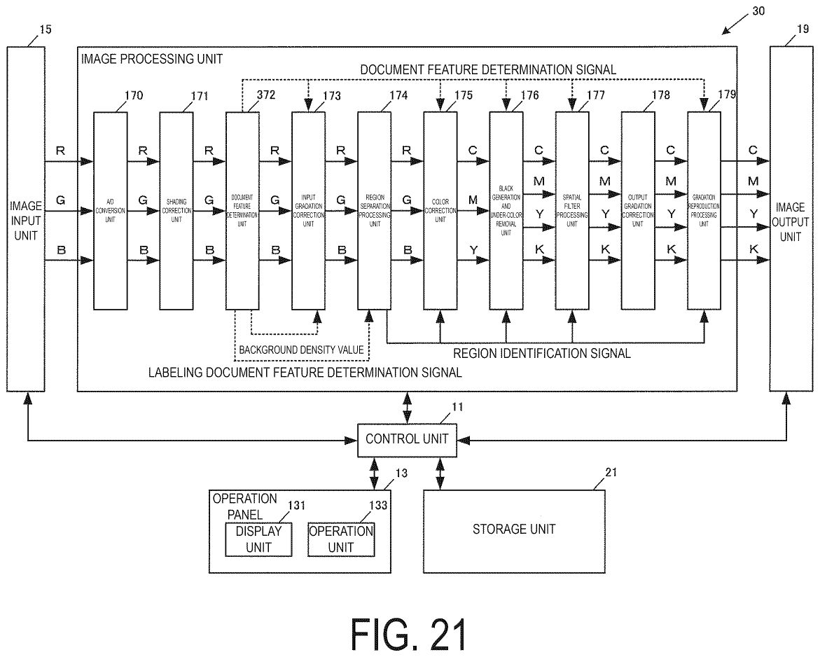

The functional configuration of a multifunction apparatus 30 according to a third embodiment will be described with reference to FIG. 21. The multifunction apparatus 30 differs from the multifunction apparatus 10 according to the first embodiment in that the multifunction apparatus 30 includes a document feature determination unit 372 instead of the document feature determination unit 172. Since configurations other than the document feature determination unit 372 can be the same as those of the first embodiment, the description thereof is omitted.

The document feature determination unit 372 outputs a labeling document feature determination signal to the region separation processing unit 174, in addition to the processing that is performed by the document feature determination unit 172 according to the first embodiment.

### 3.1.1 Image Processing Unit

### 3.1.1.1 Details of Document Feature Determination Unit

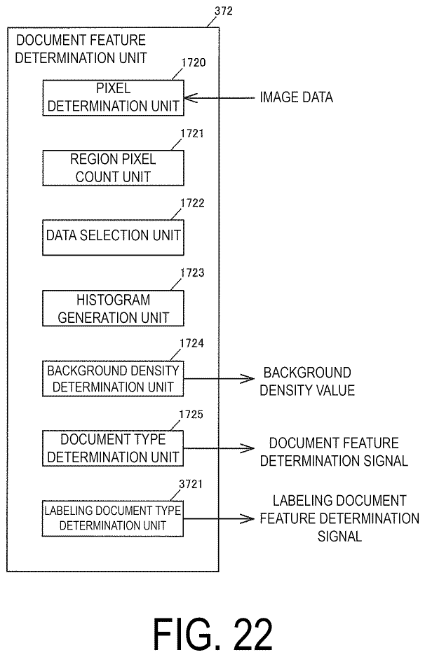

Next, details of the document feature determination unit 372 will be described. FIG. 22 is a diagram illustrating a functional configuration of the document feature determination unit 372. The document feature determination unit 372 includes a labeling document type determination unit 3721, in addition to the configuration of the document feature determination unit 172 according to the first embodiment.

The labeling document type determination unit 3721 performs a determination for determining a magnification ratio of the first resolution conversion unit 1742 before labeling processing. For example, the labeling document type determination unit 3721 compares a total sum of a background pixel count, a photograph (continuous gradation) pixel count, and the number of halftone dot pixels counted by the region pixel count unit 1721 with a predetermined threshold, and determines whether the document related to the read image is a document including a large number of background pixels, photograph pixels, or halftone dot pixels.

When the labeling document type determination unit 3721 determines that the total sum of the background pixel count, the photograph (continuous gradation) pixel count, and the number of halftone dot pixels counted by the region pixel count unit 1721 is equal to or greater than the predetermined threshold, the labeling document type determination unit 3721 outputs, to the region separation processing unit 174, the labeling document feature determination signal “0” which instructs the first resolution conversion unit 1742 to perform conversion into image data having a magnification ratio of 50% (a resolution of 300 dpi when resolution related to image reading is 600 dpi), and when the labeling document type determination unit 3721 determines that the total sum is smaller than the predetermined threshold, the labeling document type determination unit 3721 outputs, to the region separation processing unit 174, the labeling document feature determination signal “1” which instructs the first resolution conversion unit 1742 to perform conversion into image data having a magnification ratio of 25% (a resolution of 150 dpi when the resolution related to image reading is 600 dpi).

### 3.1.1.2 Details of Region Separation Processing Unit

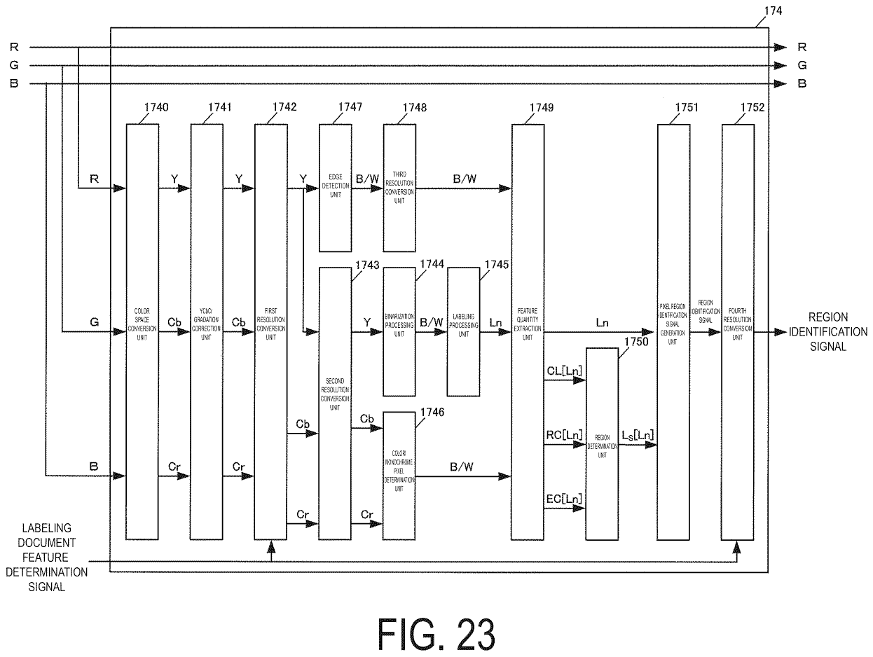

FIG. 23 is a diagram illustrating a functional configuration of the region separation processing unit 174 according to the third embodiment. In the third embodiment, with respect to the configuration of the region separation processing unit 174 illustrated in FIG. 5, the labeling document feature determination signal input from the document feature determination unit 372 (labeling document type determination unit 3721) is input to the first resolution conversion unit 1742 and the fourth resolution conversion unit 1752.

The first resolution conversion unit 1742 performs resolution conversion in accordance with the labeling document feature determination signal input from the document feature determination unit 372. When the input labeling document feature determination signal is “0”, the first resolution conversion unit 1742 converts the resolution related to document reading into image data with a magnification ratio of 50% (300-dpi resolution when the resolution related to image reading is 600 dpi). On the other hand, when the input labeling document feature determination signal is “1”, the first resolution conversion unit 1742 converts the resolution related to document reading into image data with a magnification ratio of 25% (150-dpi resolution when the resolution related to image reading is 600 dpi).

The second resolution conversion unit 1743 and the third resolution conversion unit 1748 perform resolution conversion with a magnification ratio of 50%. Therefore, when the labeling document feature determination signal is “0”, the labeling processing in the labeling processing unit 1745 and the feature quantity extraction in the feature quantity extraction unit 1749 are performed on image data (150 dpi) related to 25% of the resolution related to image reading, and when the labeling document feature determination signal is “1”, the processing is performed on image data (75 dpi) related to 12.5% of the resolution related to image reading.

For a document including few background pixels, photograph (continuous gradation) pixels, or halftone dot pixels and a large number of characters, the labeling processing tends to take a longer time and generate a large number of labels. In the third embodiment, by performing labeling processing at a lower resolution, it is possible to shorten time required for labeling processing compared with labeling processing at a high resolution. In this case, since the number of labels can also be reduced, a memory capacity for storing feature quantities for each label extracted by the feature quantity extraction unit 1749 can be kept small.

The fourth resolution conversion unit 1752 performs resolution conversion in accordance with the labeling document feature determination signal input from the document feature determination unit 372. When the input labeling document feature determination signal is “0”, the fourth resolution conversion unit 1752 converts the region identification signal representing an attribute of a (connected) region expressed at a resolution of 150 dpi, which is input from the pixel region identification signal generation unit 1751, into a region identification signal representing an attribute of a (connected) region expressed at a four times higher resolution of 600 dpi, and outputs the region identification signal. When the input labeling document feature determination signal is “1”, the fourth resolution conversion unit 1752 converts the region identification signal representing the attributes of the (connected) regions expressed at a resolution of 75 dpi, which is input from the pixel region identification signal generation unit 1751, into a region identification signal representing the attributes of the (connected) regions expressed at eight times the resolution, that is, 600 dpi, and outputs the region identification signal.

The labeling document feature determination signal may be input to the second resolution conversion unit 1743 and the third resolution conversion unit 1748 instead of being input to the first resolution conversion unit 1742, the image data may be converted to image data with a magnification of 50% when the labeling document feature determination signal is “0”, and the image data may be converted to image data with a magnification of 25% when the labeling document feature determination signal is “1”.

### 3.2 Processing Flow

Since the overall processing in the third embodiment can be performed in the same manner as in the first embodiment, description thereof is omitted.

### 3.2.1 Document Feature Determination Processing

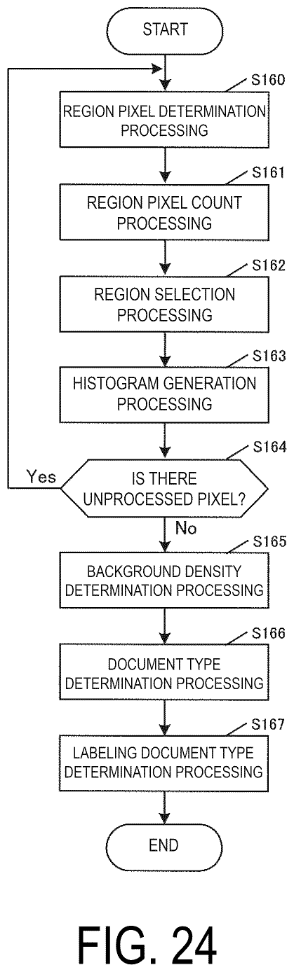

Next, document feature determination processing of the document feature determination unit 300 will be described with reference to the flowchart illustrated in FIG. 24. The document feature determination processing of the document feature determination unit 372 according to the third embodiment is obtained by adding labeling document type determination processing to the document feature determination processing of the document feature determination unit 172 as described in the flowchart of FIG. 9. Accordingly, the same processing is denoted by the same step numbers, and description thereof is omitted.

In step S167, the labeling document type determination unit 3721 performs a determination for determining a magnification ratio of the first resolution conversion unit 1742 before labeling processing. For example, the labeling document type determination unit 3721 compares a total sum of a background pixel count, a photograph (continuous gradation) pixel count, and the number of halftone dot pixels counted by the region pixel count unit 1721 with a predetermined threshold, and determines whether the document related to the read image is a document including a large number of background pixels, photograph pixels, or halftone dot pixels. The labeling document type determination unit 3721 outputs to the region separation processing unit 174 a labeling document feature determination signal for instructing to perform resolution conversion on the resolution related to the read image at a predetermined magnification ratio, and ends the processing.

### 3.2.2 Region Separation Processing

The region separation processing performed by the region separation processing unit 174 according to the third embodiment can be executed in the same manner as the processing described in the flowchart of FIG. 10 according to the first embodiment.

Here, in the first resolution conversion processing (step S202 in FIG. 10) in the third embodiment, the first resolution conversion unit 1742 performs resolution conversion processing on the image based on the YCbCr signals in accordance with the magnification ratio indicated by the labeling document feature determination signal.

Also, in the fourth resolution conversion processing (step S212 in FIG. 10), resolution conversion processing is performed to convert the region identification signal input from the pixel region identification signal generation unit 1751 into a region identification signal at a resolution of 600 dpi in accordance with the magnification ratio indicated by the labeling document feature determination signal.

As described above, according to the third embodiment, since labeling processing can be performed at a low resolution, it is possible to shorten time required for labeling processing, in addition to the effects of the first embodiment. In this case, since the number of labels can also be reduced, a memory capacity for storing feature quantities for each label extracted by the feature quantity extraction unit can be kept small.

### 4 Fourth Embodiment

### 4.1 Functional Configuration

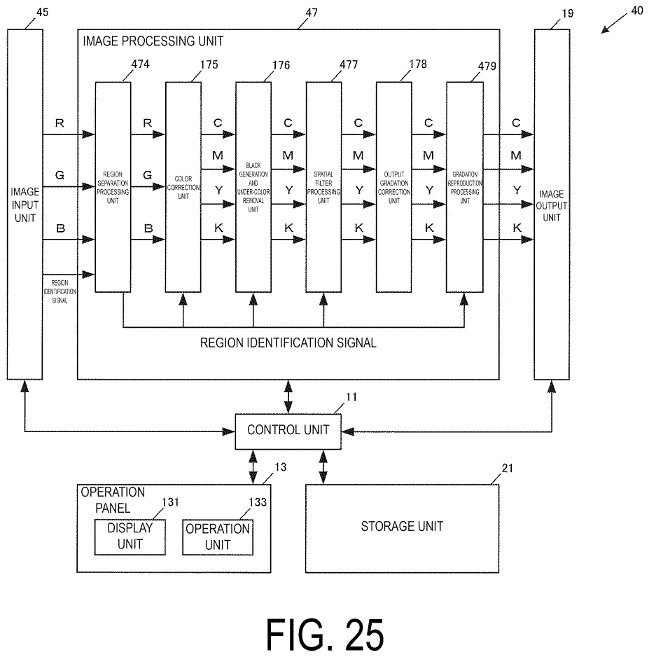

FIG. 25 is a functional block diagram of a multifunction apparatus 40 according to a fourth embodiment. Portions having the same configuration as those of the multifunction apparatus 10 according to the first embodiment are denoted by the same reference numerals, and description thereof is omitted.

The multifunction apparatus 40 includes a control unit 11, an operation panel 13, an image input unit 45, an image processing unit 47, an image output unit 19, and a storage unit 21.

The image input unit 45 outputs to the image processing unit 47 the image data stored in a storage device such as a universal serial bus (USB) memory, or image data obtained from an external device via a wired local area network (LAN) or wireless LAN.

Further, when image data is input via a printer driver, the image input unit 45 functions as a third determination unit, and also inputs a region identification signal indicating a type of object based on pixels generated by the printer driver to the image processing unit 47. For example, the image input unit 45 outputs to the image processing unit 47 a region identification signal for separating regions into a black (including gray) character object, a color character object, a monochrome vector object, a color vector object, a monochrome photograph object, a color photograph object, and no object, and the like.

### 4.1.1 Image Processing Unit

Next, the image processing unit 47 according to the fourth embodiment will be described. The image processing unit 47 includes a region separation processing unit 474, a color correction unit 175, a black generation and under-color removal unit 176, a spatial filter processing unit 477, an output gradation correction unit 178, and a gradation reproduction processing unit 479.

The region separation processing unit 474 outputs the RGB signals input from the image input unit 45 as they are, but performs region separation processing on the image based on the corrected RGB signals input from the image input unit 45. However, the region separation processing unit 474 performs region separation processing for outputting a region identification signal for further separation (classification), only on the pixels belonging to the region identification signal indicating the monochrome photograph object and color photograph object.

Moreover, based on the result of the region separation processing, the region separation processing unit 474 outputs the region identification signals representing the region separation processing results to the color correction unit 175, the black generation and under-color removal unit 176, the spatial filter processing unit 477, and the gradation reproduction processing unit 479.

Functional configurations of the color correction unit 175 and the black generation and under-color removal unit 176 can be the same as the functional configurations according to the first embodiment.

The spatial filter processing unit 477 performs spatial filter processing using a digital filter on CMYK signals input from the black generation and under-color removal unit 176. The spatial filter processing unit 477 corrects the spatial frequency characteristics of the image and prevents blurring or degradation of granularity in the output image from the image output unit 19.

For example, the spatial filter processing unit 477 performs sharpness enhancement processing on pixels separated as the region identification signal indicating a character object or a vector object, by using a filter having a large amount of high frequency component enhancement, in order to particularly enhance the reproducibility of edges, in the region separation processing performed by the region separation processing unit 474. Further, the spatial filter processing unit 477 performs low pass filtering on a region of the photographic object. When prevention of graininess degradation is unnecessary, the spatial filter processing unit 477 need not perform the above processing. The spatial filter processing unit 477 outputs the CMYK signals after spatial filter processing to the output gradation correction unit 178.

The gradation reproduction processing unit 479 performs gradation reproduction processing (halftone processing) on the CMYK signals input from the output gradation correction unit 178. For example, the gradation reproduction processing unit 479 performs binarization or multi-value processing suitable for the respective objects in accordance with the region identification signal indicating a character object, vector object, or photographic object. However, it is not always necessary to perform different binarization or multi-value processing on the region identification signals indicating the character object, the vector object, and the photographic object, and for example, the same binarization or multi-value processing may be performed on the region identification signals indicating the vector object and the photographic object.

### 4.1.1.1 Details of Region Separation Processing Unit

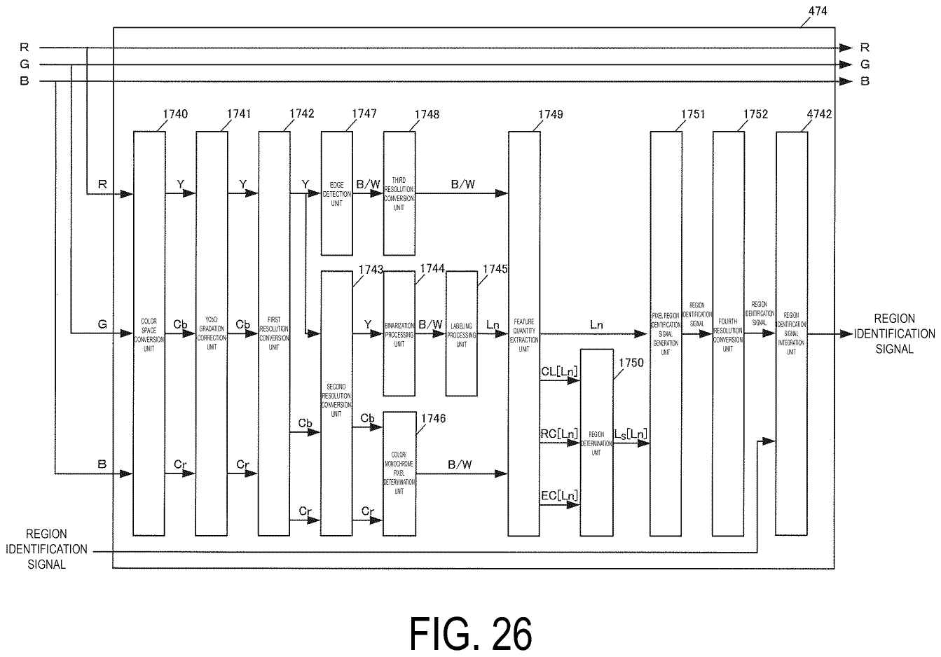

Next, details of the region separation processing unit 474 will be described. FIG. 26 is a diagram illustrating a functional configuration of the region separation processing unit 474.

The region separation processing unit 474 has a configuration in which a region identification signal integration unit 4742 is added to the configuration of the region separation processing unit 174 described in FIG. 5 of the first embodiment.

The region identification signal integration unit 4742 integrates the region identification signal input from the image input unit 45 and the region identification signal from the fourth resolution conversion unit 1752, and outputs an integrated region identification signal.

The region identification signal input from the image input unit 45 is the region identification signal generated by the printer driver, but for example, the region identification signal includes region identification signals for separating regions into a black (including gray) character object, a color character object, a monochrome vector object, a color vector object, a monochrome photograph object, a color photograph object, and no object, and the like. When the image data is photographic data such as a JPEG file or a TIFF file itself, the entire image becomes a region identification signal indicating a monochrome photograph object or a color photograph object.

When a part of the image data is one to which photographic data such as a JPEG file or a TIFF file has been pasted, the pasted portion becomes a region identification signal indicating a monochrome photographic object or a color photographic object. When the photographic data is, for example, a scan image read by a scanner, even if characters or charts are included, the portions of the characters or charts also become region identification signals indicating a monochrome photographic object or a color photographic object. Further, depending on an application that opens the image data in a terminal device such as a personal computer, there are cases in which portions that should be character objects or vector objects other than photographic data are also identified as region identification signals indicating photographic objects.

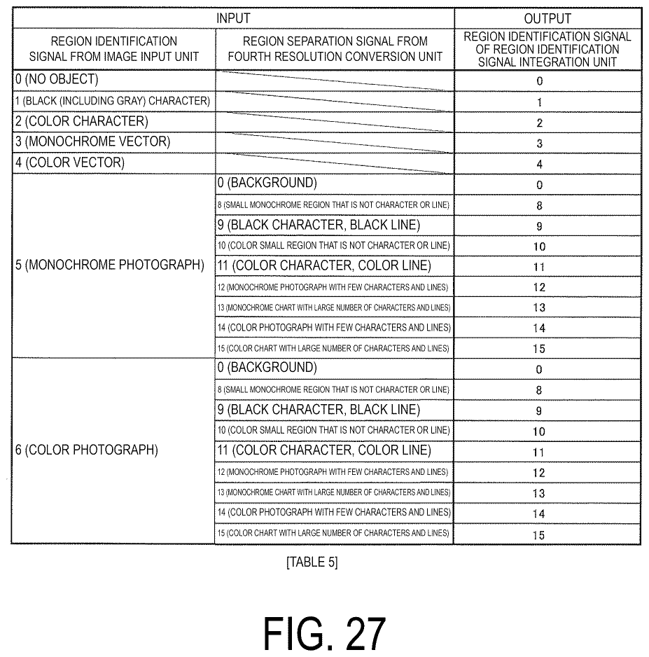

The region identification signal integration unit 4742 according to the fourth embodiment applies the region identification signal input from the fourth resolution conversion unit 1752 to pixels corresponding to the region identification signal indicating the monochrome photograph object or the color photograph object in the region identification signal input from the image input unit 45, as shown in Table 5 of FIG. 27.

In the region identification signal input from the image input unit 45, “0” represents no object, “1” represents a black (including gray) character object, “2” represents a color character object, “3” represents a monochrome vector object, “4” represents a color vector object, “5” represents a monochrome photograph object, and “6” represents a color photograph object.

Meanwhile, in the region identification signal input from the fourth resolution conversion unit 1752, “0” indicates a background image, “8” indicates a small monochrome region that is not a character or a line, “9” indicates a region of black characters or black lines, “10” indicates a small color region that is not a character or a line, “11” indicates a region of color characters or color lines, “12” indicates a region of a monochrome photograph with few characters and lines, “13” indicates a region of a monochrome chart with a large number of characters and lines, “14” indicates a region of a color photograph with few characters and lines, and “15” indicates a region of a color chart with a large number of characters and lines, as in the first embodiment.

The region identification signal integration unit 4742 outputs the region identification signal as is when the region identification signal input from the image input unit 45 is any of “0” to “4”. On the other hand, when the region identification signal input from the image input unit 45 is “5” or “6”, the region identification signal integration unit 4742 outputs the region identification signal from the fourth resolution conversion unit 1752.

### 4.1.1.2 Details of Color Correction Unit, Black Generation and Under-Color Removal Unit, Spatial Filter Processing Unit, and Gradation Reproduction Processing Unit

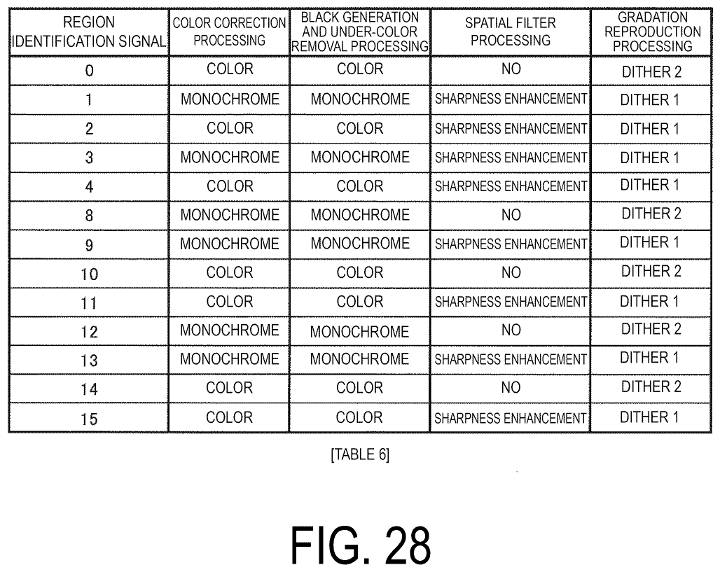

The color correction unit 175, the black generation and under-color removal unit 176, the spatial filter processing unit 477, and the gradation reproduction processing unit 479 according to the fourth embodiment perform different processing in accordance with the region identification signal input from the region separation processing unit 474, as shown in Table 6 of FIG. 28.

The color correction unit 175 converts the color space of the image based on the RGB signals input from the region separation processing unit 474 into the CMY color space. In this case, the color correction unit 175 performs correction as the monochrome output processing using a setting in which the three signals of CMY output the same value, on pixels belonging to region identification signals “1”, “3”, “8”, “9”, “12”, and “13” indicating the monochrome regions, and correction using a setting of color output processing on pixels belonging to signals other than “1”, “3”, “8”, “9”, “12”, and “13”, and outputs the corrected CMY signals to the black generation and under-color removal unit 176.

The black generation and under-color removal unit 176 performs black generation processing for generating a K signal from the CMY signal input from the color correction unit 175 and processing for generating a new CMY signal obtained by subtracting the K signal obtained by the black generation from the original CMY signal, but performs processing in which the above-described UCR rate α is set to 1, as the monochrome output processing, on the pixels belonging to the region identification signals “1”, “3”, “8”, “9”, “12”, and “13” indicating monochrome regions, and performs processing in which the UCR rate α is set to a predetermined value (0<α<1), as the color output processing, on the pixels belonging to signals other than “1”, “3”, “8”, “9”, “12”, and “13”.

The spatial filter processing unit 477 performs spatial filter processing using a digital filter on the image based on the CMYK signal input from the black generation and under-color removal unit 176, but performs sharpness enhancement processing for enhancing edge reproducibility of characters and lines on the pixels belonging to region identification signals “1”, “2”, “3”, “4”, “9”, “11”, “13”, and “15” indicating the regions of the characters or lines or the chart regions including a large number of characters or lines, and does not perform the sharpness enhancement processing on pixels belonging to signals other than “1”, “2”, “3”, “4”, “9”, “11”, “13”, and “15”.

The gradation reproduction processing unit 479 performs gradation reproduction processing on the image based on the CMYK signal input from the output gradation correction unit 178, but performs dithering processing 1 for emphasizing the reproducibility of the characters or lines on the pixels belonging to the region identification signals “1”, “2”, “3”, “4”, “9”, “11”, “13”, and “15” indicating the regions of the characters or lines or the chart regions including a large number of characters or lines. On the other hand, gradation reproduction processing unit 479 performs dither processing 2 for emphasizing photographic gradation reproducibility on the pixels belonging to signals other than “1”, “2”, “3”, “4”, “9”, “11”, “13”, and “15”.

### 4.2 Processing Flow

### 4.2.1 Overall Processing

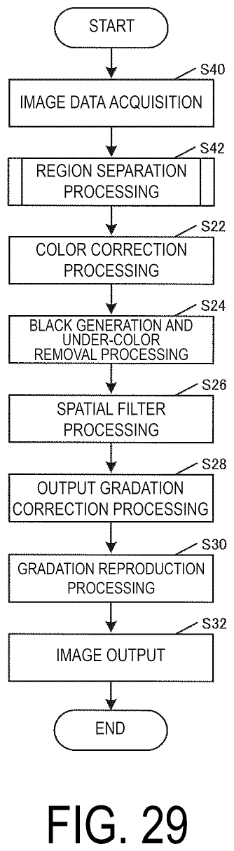

Next, overall processing of the multifunction apparatus 40 according to the fourth embodiment will be described with reference to a flowchart in FIG. 29. The processing illustrated in FIG. 29 is processing that is executed by the control unit 11 reading a program stored in the storage unit 21 and operating as each functional block. The processing shown in FIG. 29 will be described as processing that is executed by receiving, via the printer driver, an instruction from the user to execute a print job. Since the processing related to steps S22 to S32 can be performed in the same manner as that described in the flowchart of FIG. 8 according to the first embodiment, the processing is denoted by the same reference numeral, and the description thereof is omitted.

First, the control unit 11 controls the image input unit 45 to acquire image data stored in a storage device such as a USB memory or image data (RGB signal) from an external device via a wired or wireless LAN. In this case, the image input unit 45 also acquires a region identification signal based on the obtained image data (step S40).

Subsequently, the control unit 11 controls each functional unit of the image processing unit 47 to perform image processing on the image data (RGB signal).

The region separation processing unit 474 performs region separation processing on the RGB signal input from the image input unit 45 (step S42).

### 4.2.2 Region Separation Processing

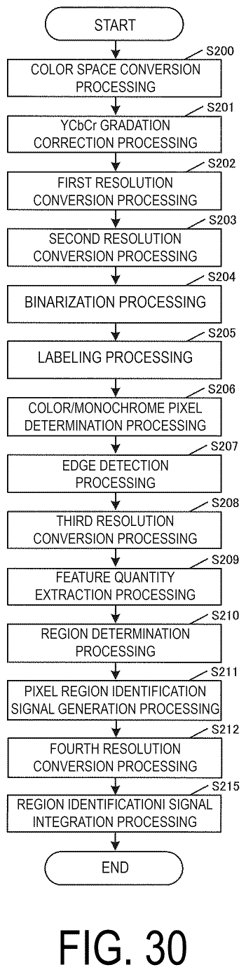

Next, region separation processing of the region separation processing unit 474 will be described with reference to the flowchart in FIG. 30. Since the processing related to steps S200 to S212 can be performed in the same manner as that described in the flowchart of FIG. 10 according to the first embodiment, the processing is denoted by the same reference numeral, and the description thereof is omitted.

In step S215, the region identification signal integration unit 4742 integrates the region identification signal input from the image input unit 45 and the region identification signal input from the fourth resolution conversion unit 1752, and outputs an integrated region identification signal.

As described above, according to the fourth embodiment, since it is possible to integrate the region identification signal based on image data input via the printer driver or the like with the region identification signal from the fourth resolution conversion unit, in addition to the effects of the first embodiment, it is possible to separate characters or charts even in portions of region identification signals indicating monochrome or color photograph objects.

The present disclosure is not limited to the embodiments described above and can be modified in various ways.

That is, embodiments obtained by appropriately combining technical means within the scope not departing from the gist of the present disclosure are also included within the technical scope of the present disclosure.

Further, although the above-described embodiments are described separately for convenience of description, it is obvious that the embodiments may be executed in combination within a technically possible scope.

Further, in the embodiments, a program operating on each device is a program that controls a CPU or the like (a program for causing a computer to function) to realize the functions of the above-described embodiments. Information handled by such a device is temporarily stored in a temporary storage device (for example, a RAM) during the processing and then stored in various storage devices such as read only memories (ROMs) and HDDs, and is read, modified, and written by the CPU as necessary.

Here, a computer-readable non-transitory recording medium on which a program is recorded in an information processing apparatus may be any of a semiconductor medium (for example, a ROM or a non-volatile memory card), an optical recording medium/magnetic optical recording medium (for example, a digital versatile disc (DVD), magneto optical disc (MO), mini disc (MD), compact disc (CD), or Blu-ray (BD; registered trademark) disc)), a magnetic recording medium (for example, a magnetic tape or flexible disk), and the like. In this case, the program recorded on the recording medium is read by the computer of the information processing apparatus and executed by the computer, such that not only the functions of the above-described embodiment are enabled, but also functions of the disclosure are enabled by performing processing in cooperation with an operating system, another application program, or the like based on instructions of the program.

Further, when a program is distributed in a market, the program can be stored in a portable recording medium and distributed, or can be transferred to a server computer connected via a network such as the Internet. In this case, it is obvious that a storage device of the server computer is also included in the disclosure.

Further, each functional block or feature of the device used in the above-described embodiment can also be implemented and executed by an electric circuit, such as an integrated circuit or a plurality of integrated circuits. An electric circuit designed to implement the function described herein may include a general-purpose processor, a digital signal processor (DSP), an application specific integrated circuit (ASIC), a field programmable gate array (FPGA) or other programmable logic devices, discrete gate or transistor logic, discrete hardware components, or a combination thereof. The general-purpose processor may be a microprocessor or may be a known processor, controller, microcontroller, or state machine. The electric circuit described above may include a digital circuit or may include an analog circuit. Further, when an integrated circuit technology for replacement into a current integrated circuit emerges with the development of semiconductor technology, a new integrated circuit based on the technology may also be used in one or more aspects of the disclosure.

1. A processing apparatus comprising:
a conversion unit configured to perform resolution conversion on an input multi-value image;
an acquisition unit configured to acquire connected region information in which a plurality of pixels are connected, from a binary image obtained by binarizing a low resolution image after conversion;
an extraction unit configured to calculate a pixel count, an edge pixel ratio, and a color pixel ratio for each connected region based on the connected region information;
a first determination unit configured to determine, for each connected region, an attribute of the region based on the pixel count, the edge pixel ratio, and the color pixel ratio for the connected region; and
a generation unit configured to generate image data by applying predetermined image processing in accordance with the attribute of the region.

2. The processing apparatus according to claim 1, wherein the conversion unit converts a resolution of the connected region into a resolution of the input multi-value image and corrects the attribute of the region based on position information of pixels of the input multi-value image.

3. The processing apparatus according to claim 1, further comprising:
a second determination unit configured to determine the attribute of the region in units of a plurality of pixels including an attention pixel for each pixel of the input multi-value image; and
an integration unit configured to integrate a determination result of the first determination unit with a determination result based on the second determination unit.

4. The processing apparatus according to claim 1, wherein the conversion unit performs resolution conversion on the multi-value image at a preset resolution or a resolution determined based on a processed image obtained after background removal processing of the multi-value image.

5. The processing apparatus according to claim 3, further comprising:
a third determination unit configured to determine the attribute of the region based on a multi-value image input from an external input device,
wherein the integration unit integrates the determination result of the first determination unit with a determination result of the third determination unit.

6. The processing apparatus according to claim 1, wherein the acquisition unit acquires, as the connected region information, labeling information in which labels are assigned to the connected regions.

7. A processing method comprising:
performing resolution conversion on an input multi-value image;
acquiring connected region information in which a plurality of pixels are connected, from a binary image obtained by binarizing a low resolution image after conversion;
calculating, based on the connected region information, a pixel count, an edge pixel ratio, and a color pixel ratio for each connected region;
determining, for each connected region, an attribute of the region based on the pixel count, the edge pixel ratio, and the color pixel ratio for the connected region; and
generating image data by applying predetermined image processing in accordance with the attribute of the region.

8. A non-transitory computer-readable recording medium storing a program that, when executed by a computer, causes the computer to perform:
performing resolution conversion on an input multi-value image;
acquiring connected region information in which a plurality of pixels are connected, from a binary image obtained by binarizing a low-resolution image after conversion;
calculating, based on the connected region information, a pixel count, an edge pixel ratio, and a color pixel ratio for each connected region;
determining, for each connected region, an attribute of the region based on the pixel count, the edge pixel ratio, and the color pixel ratio for the connected region; and
generating image data by applying predetermined image processing in accordance with the attribute of the region.
